(19) United States
(12) Patent Application Publication
(10) Pub. No.: US 2011/0002664 A1
(43) Pub. Date: Jan. 6, 2011

(54) RECORDING REQUESTING APPARATUS, RECORDING APPARATUS, SYSTEM, RECORDING APPARATUS SELECTING METHOD AND COMPUTER PROGRAM

(76) Inventors: Hideki Nishimura, Osaka-shi (JP); Hiroyuki Nakaoka, Osaka-shi (JP)

Correspondence Address: BIRCH STEWART KOLASCH & BIRCH, PO BOX 747, FALLS CHURCH, VA, 22040-0747, US

(21) Appl. No.: 12/865,983

(22) PCT Filed: Feb. 20, 2009
(86) PCT No.: PCT/JP2009/053060

§ 371 Date: Aug. 3, 2010

(30) Foreign Application Priority Data
Feb. 26, 2008 (JP) 2008-044820

(51) Int. Cl. H04N 5/76; G06F 17/30

(52) U.S. Cl. 386/297; 707/769; 707/723; 707/E17.039

(57) ABSTRACT

In a system having a program viewing apparatus and a plurality of recording apparatuses connected to a network, a program viewing apparatus 31 allowing easy selection of a recording apparatus includes: a tuner 101, a program information storage unit 121 for storing program list information output from tuner 101; an IP communication unit 102 for transmission/reception to/from the recording apparatus; and a processing unit 110 for performing a process of selecting a recording apparatus. When a user instructs recording of a program he/she is watching, processing unit 110 transmits the program information read from program information storage unit 121 together with a search request, to recording apparatuses including a recording apparatuses 32. If a prescribed similarity relation is found between the received program information and recording history, the recording apparatus 32 notifies the program viewing apparatus 31 that it is eligible for recording the program. Based on the notice, program viewing apparatus 31 selects a recording apparatus optimal for recording the program.

### TECHNICAL FIELD

The present invention relates to a system having at least one recording requesting apparatus and a plurality of recording apparatuses each connected to a network and, specifically, it relates to a technique of selecting, in response to a program recording instruction, a recording apparatus most suitable for the program among the recording apparatuses on the network, in view of recording history.

### BACKGROUND ART

Recently, a home network (hereinafter referred to as “home NW”) having a plurality of digital AV (Audio Visual) apparatuses in a home connected to each other, to allow users to enjoy video and music content at any place has attracting attention. Specifically, the home NW is formed by connecting mutually compatible AV devices such as DLNA (Digital Living Network Alliance) supporting devices and IPTV (Internet Protocol Television), a PC (Personal Computer) and the like. Connection may be realized by wired LAN (Local Area Network) and WLAN (Wireless Local Area Network).

One possible reason for the attraction is that, because of price decline, it becomes more common these days to have one AV device per person rather than one device per family. Assume, for example, that a shared device is placed in a living room and a personal device is placed in a personal room, and home NW including these devices is formed. Then, it is possible to reproduce content saved in the shared device on the personal device, or vice versa.

As another application of home NW, it may be possible that a device on the home NW issues a record instruction to another device having a recording function. A mechanism realizing such an operation is now under investigation. If realized, it becomes possible for a user enjoying content on the shared device with his/her family in the living room to instruct recording by the recording device owned by the user and placed in the user's room, through the shared device. It is unnecessary for the user to go away from the living room to instruct his/her own device to record. Further, it is possible for the user to take in the content in his/her own library.

As regards the recording instruction, a possible problem is how to select the recording apparatus. By way of example, assume that selectable recording apparatuses are displayed on a display portion of an apparatus that receives the instruction, and selection is made by operating, for example, a cursor by a remote controller. Then, every time the user issues a recording instruction, he/she faces troublesome operations.

If the apparatus that receives the recording instruction is capable of authenticating an instructor, it becomes possible to select a recording apparatus owned by the instructor based on the authentication information. In this connection, Patent Document 1 discloses a technique in which a user viewing a TV (television) shared by a plurality of users instructs channel selection from an operating apparatus in which his/her identifier is registered. The instruction signal includes a control code requesting channel selection and the user identifier superposed thereon. Therefore, The TV can store, in a user-by-user database identified by the identifier, related information of viewed programs (titles, genre, characters and broadcast time). When an instruction to recommend a program is received from the user, the stored information is used to analyze preference of the individual and to determine a program to be recommended based on the results. As the instruction to recommend a program, again, a signal including a control code requesting program recommendation and the user identifier superposed thereon is transmitted from the operating apparatus. Receiving this signal, the TV reads the corresponding stored information identified by the identifier.

Utilizing this technique, if a signal having the user identifier superposed is received from the operating apparatus instructing recording and the apparatus receiving the recording instruction authenticates the user who issued the instruction, it becomes possible to easily select the recording apparatus owned by the individual. Then, without troublesome operations for selecting the recording apparatus as described above, the recording instruction and selection of the recording apparatus can be done in a simple manner.

### PRIOR ART DOCUMENTS

### Patent Document 1: Japanese Patent Laying-Open No. 2006-41662

Non-Patent Document 1: The National Association of Commercial Broadcasters in Japan, Broadcasting Standard “Chapter 18: Time Standard of Advertisement” [online], January 2004 [searched on Jan. 15, 2008], Internet <URL:http:k//www.mro.co.jp/mro-info/18kokoku.htm>

### DISCLOSURE OF THE INVENTION

### Problems to be Solved by the Invention

The technique of Patent Document 1 requires an apparatus that can transmit the control code with the identifier superposed. As an apparatus superposing individual information on transmission signals, a portable telephone is well known. Considering a possibility that a recording instruction be issued to the shared apparatus while the user views content on the shared apparatus in a living room, it may be troublesome for the user to hold his/her portable telephone.

Therefore, an object of the present invention is to provide a program recording system allowing, when an apparatus on the home NW receives a program recording instruction, selection of a recording device suitable for executing recording of the program, without necessitating any troublesome operations or works to authenticate an individual.

### Means for Solving the Problems

According to a first aspect, the present invention provides a recording requesting apparatus connected to a network having a recording apparatus or recording apparatuses connected thereto. The recording requesting apparatus includes: program information obtaining means for obtaining program information related to a specific program; recording apparatus detecting means for detecting the recording apparatus or recording apparatuses connected to the network; a search request transmitting means for transmitting, through the network, a search request for the program information obtained by the program information obtaining means, to a recording apparatus or recording apparatuses detected by the recording apparatus detecting means; recording apparatus selecting means for selecting a recording apparatus for recording the program, based on a notice or notices from the recording apparatus or recording apparatuses transmitted in response to the search request from the search request transmitting means; and recording request transmitting means for transmitting a recording request related to recording of the program, to the recording apparatus selected by the recording apparatus selecting means.

In the recording requesting apparatus, the program information obtaining means obtains program information related to a specific program. The recording apparatus detecting means detects a recording apparatus or recording apparatuses connected to the network. The search request transmitting means transmits a search request related to the program, including the obtained information related to the program, to the recording apparatus or recording apparatuses on the network. Based on a notice from the recording apparatus or recording apparatuses transmitted in response to the search request, the recording apparatus selecting means selects the recording apparatus for recording the program. The recording request transmitting means transmits the request related to recording of the program to the selected recording apparatus.

The recording requesting apparatus selects the recording apparatus suitable for recording the specific program from among the recording apparatuses on the network. Selection is made based on the content of the notice returned from the recording apparatuses in accordance with the information related to the program transmitted by the recording requesting apparatus. The content of the notice reflects the result of search carried out using the information related to the program as a key, on the information in the recording apparatuses.

By way of example, in the home NW, assume that the user instructed recording of a certain program, through the shared recording requesting apparatus. It is highly likely that information related to the program and the information in the recording apparatus owned by the user reflect the user's preference. Therefore, the information in the recording apparatus owned by the user has the highest possibility to present matching or closely matching result in the search for the information related to the program. Consequently, the notice from the recording apparatus owned by the user highly likely reflects the matching or closely matching results of search. If the recording requesting apparatus selects the recording apparatus that notified the contents reflecting the matching or closely matching search result as the apparatus for recording the program, it is highly possible that the recording apparatus owned by the user is selected by the recording requesting apparatus in the above example.

From the foregoing, by the recording requesting apparatus, it is possible to select the recording apparatus owned by an individual as the recording apparatus for recording the program, without necessitating troublesome operations and works of individual authentication.

Preferably, the recording requesting apparatus further includes program list information obtaining means for obtaining program list information including the program information. The program information obtaining means includes means for obtaining the program information included in the program list information obtained by the program list information obtaining means.

More preferably, the program list information obtaining means includes means for obtaining the program list information from a server storing the program list information through the network.

More preferably, the recording requesting apparatus further includes broadcast signal processing means for receiving broadcast signals, and processing and outputting program list information included in the broadcast signals; and program list information storage means for storing the program list information output from the broadcast signal processing means.

More preferably, the program list information obtaining means includes means for obtaining program list information stored in the program information storage means.

More preferably, the broadcast signal is an RF signal. The broadcast signal processing means includes means for receiving RF signals and processing and outputting program list information included in the RF signals.

More preferably, the broadcast signal is streaming data of IP multicast. The broadcast signal processing means includes means for receiving the streaming data and processing and outputting program list information included in the streaming data.

More preferably, the recording requesting apparatus further includes display means for displaying either or both of the video signal output from the broadcast signal processing means and the program list information read from the program list information storage means, in accordance with a user instruction.

Preferably, the search request transmitting means includes means for obtaining information related to a program of which recording is requested by the user and of which video signals are being output to the display means, and for transmitting, to a recording apparatus or recording apparatuses detected by the recording apparatus detecting means, a search request related to the program through the network.

When the user instructs recording of the program which he/she is watching, the recording requesting apparatus transmits information related to the program being watched to the recording apparatuses on the network. Based on the notices in accordance with the results of search related to the program being watched transmitted from the recording apparatuses, the recording requesting apparatus selects a recording apparatus suitable for recording the program that is being watched.

Preferably, the search request transmitting means includes means for obtaining information related to a program selected by the user from a program list that is being output by the display means, from the program list information stored in the program list information storage means, and for transmitting a search request related to the program to a recording apparatus or recording apparatuses detected by the recording apparatus detecting means, through the network.

When the user selects a program from the program list displayed on the display means and instructs recording of the program, the recording requesting apparatus transmits information related to the program to the recording apparatuses on the network. Based on the notices in accordance with the results of search related to the program selected by the user transmitted from the recording apparatuses, the recording requesting apparatus selects a recording apparatus suitable for recording the program selected by the user.

Preferably, the recording apparatus selecting means includes first determining means for determining, if no recording apparatus notifies that it will execute recording of the program, and a recording apparatus or recording apparatuses notify eligibility for recording the program, whether or not only one recording apparatus is eligible, and means for displaying, if it is determined by the first determining means that more than one recording apparatuses are eligible, information related to the corresponding recording apparatuses on the display means, and for receiving selection by the user.

If a plurality of recording apparatuses are notified as suitable for recording the program, the selecting means causes the display means to display information of the recording apparatuses. From the display, the user can select the recording apparatus for recording the program.

Preferably, the recording apparatus selecting means further includes second determining means for determining, if no recording apparatus notifies that it will execute recording of the program, and no recording apparatus notifies eligibility for recording the program, based on a notice from a predetermined recording apparatus, whether or not recording of the program is possible by the predetermined recording apparatus.

Preferably, the recording request transmitting means includes means for transmitting, if it is determined by the first determining means that only one recording apparatus is eligible, or if it is determined by the second determining means that recording of the program is possible by the predetermined recording apparatus, a request related to recording of the program to the recording apparatus and, otherwise, for transmitting a request related to recording of the program to the recording apparatus selected by the selecting means.

In the recording requesting apparatus, if no recording apparatus notifies execution of recording of a specific program and only one recording apparatus notifies that it is suitable for recording the program, that one recording apparatus is selected. If a plurality of recording apparatuses notify that they are suitable for recording the program, one recording apparatus is selected based on the user's choice. If no recording apparatus notifies execution of recording of a specific program and recording of the program is possible by a predetermined recording apparatus, the predetermined apparatus is selected. The recording request transmitting means transmits the request related to recording of the program to the selected recording apparatus. If there is a recording apparatus that notifies execution of recording of the program, no recording apparatus is selected, and if no recording apparatus notifies execution of recording of a specific program, no recording apparatus notifies that it is suitable for recording the program and recording of the program by the predetermined recording apparatus is impossible because, for example, it is busy, then no recording apparatus is selected.

Preferably, the search request transmitting means includes means for starting time measurement in response to a channel switch instruction from the user, and if new channel switch instruction is not received even after a prescribed time period, for determining a program of which video signals are being output by the display means to be the specific program, and means for obtaining information related to the program from the program list information stored in the program list information storage means, and for transmitting a search request related to the program to a recording apparatus or recording apparatuses detected by the recording apparatus detecting means through the network.

If the user views the same program for a prescribed time period or longer, the search request transmitting means transmits a search request related to the program, including information related to the program, to the recording apparatuses on the network. Based on the notices transmitted from the recording apparatuses in response, the recording apparatus selecting means selects the recording apparatus for recording the program. If the user instructs recording of the program thereafter, selection of the recording apparatus has been done by that time and, therefore, quick response to the recording instruction is possible.

Preferably, the recording requesting apparatus further includes means for controlling the program information transmitting means and the recording apparatus selecting means such that, when the broadcast signal processing means receives the broadcast signals, regarding each of a plurality of programs of which related information is included in the program list information in the broadcast signals as a specific program, a series of operations related to the specific program is performed, whereby a recording apparatus for recording the program is selected for each of the plurality of programs.

Under the control of this means, using reception of the broadcasting signals by the broadcasting signal processing means as a trigger, the search request transmitting means obtains information related to each of the plurality of programs, related pieces of information of which are included in the program list information in the broadcasting signals. Further, it transmits a search request for the corresponding program, including the information related to the program, to the recording apparatuses on the network. Under the control of this means, the recording apparatus selecting means selects, for each of the plurality of programs, the recording apparatus for recording the program, based on the notices transmitted from the recording apparatuses in response to the search request.

In the recording requesting apparatus, for each of the plurality of programs included in the received program list information, the recording apparatus for recording is selected. Therefore, if the user issues a recording instruction of any of the plurality of programs, selection of the recording apparatus has been done by that time and, therefore, after receiving the recording instruction, the request for recording can be transmitted to the selected recording apparatus immediately without waiting for the notice from the recording apparatus. Faster response to the recording instruction becomes possible.

Preferably, the recording apparatus selecting means includes: means, selecting, based on a notice or notices from the recording apparatus or recording apparatuses transmitted in response to the search request from the search request transmitting means, a recording apparatus for recording the program, for storing an identifier of the selected recording apparatus in association with information related to the program; and means for reading, when the user instructs recording of the program, the identifier of the recording apparatus stored in association with the information related to the program from the means for storing, and for selecting the recording apparatus identified by the identifier to be the recording apparatus for recording the program.

If there is a recording apparatus notifying that it is suitable for recording a specific program, the recording requesting apparatus stores the identifier of the recording apparatus in association with the information related to the program. If the user instructs recording of the specific program, the identifier stored in association with the information related to the program is read, and the recording apparatus identified by the identifier is selected as the recording apparatus for recording the specific program. When the user instructs recording of the program, selection of the recording apparatus has been already done. Therefore, after receiving the recording instruction, the request for recording can be transmitted to the selected recording apparatus immediately based on the stored identifier, without waiting for the notice from the recording apparatuses on the network. Thus, faster response to the recording instruction becomes possible.

Preferably, the means for storing includes: first storage means for storing, if no recording apparatus notifies that it will execute recording of the program, and a recording apparatus or recording apparatuses notify eligibility for recording the program, an identifier or identifiers of the recording apparatuses in association with the information related to the program; and second storage means, determining, if no recording apparatus notifies that it will execute recording of the program, and no recording apparatus notifies eligibility for recording the program, based on a notice from a predetermined recording apparatus, whether or not recording of the program is possible by the predetermined recording apparatus, and if it is determined that recording of the program by the predetermined recording apparatus is possible, for storing an identifier of the predetermined recording apparatus in association with the information related to the program. The means for selecting includes: means for reading, when the user instructs recording of the specific program, the identifier of a recording apparatus stored in association with the program by the first or second storage means; first selecting means, if only one identifier is read by the reading means, for selecting the recording apparatus identified by the identifier as the recording apparatus for recording the program; second selecting means, if a plurality of identifiers are read by the reading means, for displaying information related to the recording apparatuses identified by the identifiers and, if the user selects any of the displayed recording apparatuses, for selecting the recording apparatus to be the recording apparatus for recording the program; and means for presenting an error display to the user, if no identifier is stored by the first or second storage means.

If there is no recording apparatus notifying execution of recording of a specific program and there is a recording apparatus notifying that it is suitable for recording the program, the first storage means stores the identifier of the recording apparatus in association with the information related to the program. If there is no recording apparatus notifying that it is suitable for recording the program and a predetermined recording apparatus is capable of recording the specific program, the second storage means stores the identifier of the recording apparatus in association with the information related to the program. If the user instructs recording of the specific program, the identifier stored in association with the information related to the program is read from the first storage means or from the second storage means. If no identifier is read, an error display is given to the user. If one identifier is stored, the recording apparatus indicated by the stored identifier is selected as the recording apparatus for recording the program. If a plurality of identifiers are stored, information related to the recording apparatuses indicated by the identifiers is displayed to the user, and based on the user's choice, a recording apparatus is selected for recording the program.

When the user instructs recording of the program, selection of the recording apparatus has been already done. Thus, faster response to the recording instruction becomes possible.

Preferably, the recording requesting apparatus further includes: recording history storage means for storing pieces of information related to a recorded program or programs and an identifier of a recording apparatus that recorded the recorded program in association with each other; and means for obtaining, when the user instructs recording of the specific program, information related to the recorded program from the information stored in the recording history storage means. The information related to the program and the information related to the recorded program each include a prescribed attribute value. The recording requesting apparatus further includes: execution causing means, comparing the information related to the program with the information related to the recorded program, and determining, if a value of the prescribed attribute included in the information related to the program and a value of the prescribed attribute included in any of the pieces of information related to the recorded programs satisfy a prescribed similarity relation, that a recording apparatus indicated by the identifier stored in association with the piece of information related to the recording apparatus in the recording history storage means is eligible for recording the program, and otherwise for causing the search request transmitting means to execute a process. The recording apparatus selecting means includes: means for selecting a recording apparatus for recording the program based on a result of determination by the execution causing means and a notice from the recording apparatus; and means for storing, based on the notice from the recording apparatus and the recording request transmitting means transmitted the request related to recording of the program, the information related to the program and an identifier of a recording apparatus for recording the program in association with each other in the recording history storage means.

In the recording requesting apparatus, the recording history storage means stores the information related to the recorded program in association with the identifier of the recording apparatus that recorded the recorded program. If the user instructs recording of a program, the obtaining means obtains the information related to the recorded program from the information stored in the recording history storage means. The execution causing means compares the information related to the program of which recording is requested by the user with the pieces of information related to recorded programs. In connection with a prescribed attribute value, if a prescribed similarity relation is found between the information related to the program and any piece of information related to recorded programs, the execution causing means determines that the recording apparatus indicated by the identifier stored in association with the corresponding piece of information related to the recorded program is suitable for recording the program. Otherwise, the recording requesting apparatus transmits the search request related to the program, including the information related to the program, to the recording apparatuses on the network. The recording requesting apparatus further determines, based on notices from the recording apparatuses in response to the search request, a recording apparatus for recording the program.

In connection with a prescribed attribute value, if a prescribed similarity relation is found between the information related to the program of which recording is requested and any of the pieces of information related to recorded programs included in the recording history, the recording requesting apparatus selects the recording apparatus that recorded the corresponding recorded program as the recording apparatus for recording the program. Assume, for example, that the user instructs recording of a program from the shared recording requesting apparatus. It is highly possible that the information related to this program is similar to pieces of information related to programs recorded by the recording apparatus owned by the user, as they both reflect the user's preferences. Therefore, it is highly likely that the recording apparatus owned by the user is determined to be better suited for recording the program, than other recording apparatuses on the network. Accordingly, it is possible to select the recording apparatus owned by an individual as the recording apparatus for recording the program, without necessitating troublesome operations and works of individual authentication. Further, since the process is done in the recording requesting apparatus, faster response to the recording instruction from the user becomes possible, as compared with the approach in which a recording apparatus is determined after receiving notices from recording apparatuses.

Preferably, the recording request related to recording of the program is a request for reserving recording.

If the program is being broadcast, the recording requesting apparatus transmits the recording request to the selected recording apparatus. If the program is scheduled to be broadcast in the future, the recording apparatus transmits a recording reservation request to the selected recording apparatus.

Preferably, the program information obtaining means includes means for obtaining program information from any of an electronic mail received from another apparatus, information extracted from a bar code, and an identifier of program information input by the user.

According to a second aspect, the present invention provides a recording apparatus connected to a network having at least one recording requesting apparatus connected thereto. The recording requesting apparatus transmits a search request including information of a specific program, related to the program, to the recording apparatus. The recording apparatus includes: recording information storage means for storing recording information including recording history or/and recording plan by the recording apparatus; determining means for comparing the information related to the program specified by the search request received from the recording requesting apparatus with the recording information stored in the recording information storage means, for determining whether or not the recording apparatus is eligible for recording the program, in accordance with the result of comparison; notifying means for providing a notice in accordance with the result of determination by the determining means, to the recording requesting apparatus that transmitted the search request; and recording process executing means, responsive to a request related to recording of the program transmitted from the recording requesting apparatus, for executing a process related to recording of the program.

In the recording apparatus, the recording information storage means stores recording information including recording history or/and recording plan by the recording apparatus. In response to the search request received from the recording requesting apparatus, the determining means compares the information related to the program specified by the search request with the recording information stored in the recording information storage means, and in accordance with the result of comparison, determines whether the recording apparatus is suitable for recording the program. The notifying means issues a notice corresponding to the result of determination by the determining means, to the recording requesting apparatus that transmitted the search request. If the recording requesting apparatus transmits a request related to recording of the program to the recording apparatus selected based on the notices from the recording apparatuses on the network, in response, the recording executing means executes processes related to recording of the program.

The recording apparatus compares the information related to the program and the recording information including the recording history or/and recording plan of the recording apparatus, and determines whether the recording apparatus is suitable for recording the program in accordance with the result of comparison.

By way of example, assume that in the home NW described above, the user instructs recording of a program from the shared recording requesting apparatus. It is highly possible that the information related to this program is similar to the recording information of the recording apparatus owned by the user, as they both reflect the user's preferences. If it is the case that the recording apparatus determines whether or not it is suitable for recording the program based on the degree of similarity, it is highly likely that the recording apparatus owned by the user determines that it is suitable for recording the program and sends the notice to that effect. If it is the case that the recording requesting apparatus receiving the notice selects a recording apparatus that notifies the contents reflecting the matching or closely matching search result to be the recording apparatus for recording the program, it is highly likely in the example above that the recording requesting apparatus selects the recording apparatus owned by the user.

From the foregoing, by the recording apparatus, it is possible to select the recording apparatus owned by an individual as the recording apparatus for recording the program, without necessitating troublesome operations and works of individual authentication.

Preferably, the information related to the specific program includes information related to broadcast time of the program. The recording apparatus further includes: first determining means for comparing the information related to the program included in the search request received from the recording requesting apparatus with state of operation of the recording apparatus, for determining whether or not the recording apparatus will be recording at the broadcast time of the program; and second determining means for determining, if it is determined by the first determining means that the recording apparatus will be recording at the broadcast time, whether or not the program that will be recorded by the recording apparatus at the broadcast time is the same as the program.

Preferably, the recording apparatus further includes means for providing, if it is determined by the second determining means that the program that will be recorded by the recording apparatus at the broadcast time is the same as the program, a notice that recording of the program will be executed by the recording apparatus and, otherwise, a notice that the recording apparatus will be recording another program, to the recording requesting apparatus that transmitted the search request.

If the recording apparatus is set to record a program at the broadcasting time of the program, the recording apparatus notifies the recording requesting apparatus as the transmission source of the search request that it will execute recording of the program. If the recording apparatus will be recording another program at the broadcasting time of the program of interest, the recording apparatus transmits a notice to that effect to the recording requesting apparatus.

Preferably, the recording information includes pieces of information related to a plurality of recorded and to-be-recorded programs. The information related to the program and each of the pieces of information related to the recorded and to-be-recorded programs each include a prescribed attribute value; and the determining means includes first determining means for comparing the information related to the program with each of the pieces of information related to the recorded and to-be-recorded programs stored in the recording information storage means, for determining, if the prescribed attribute value included in the information related to the program and the prescribed attribute value included in any of the pieces of information related to the recorded and to-be-recorded programs satisfy a prescribed similarity relation, that the recording apparatus is eligible for recording the program.

In the recording apparatus, the recording information storage means stores pieces of information related to a plurality of recorded programs and programs to be recorded. Receiving the search request related to the program from the recording requesting apparatus, the first determining means compares the information related to the program with the pieces of information related to the plurality of recorded programs and programs to be recorded. In connection with a prescribed attribute value, if a prescribed similarity relation is found between the information related to the program and any of the pieces of information related to a plurality of recorded programs and programs to be recorded, the first determining means determines that the recording apparatus is suitable for recording the program, and otherwise, it determines that the recording apparatus is not suitable for recording the program.

The recording apparatus determines whether or not the recording apparatus is suitable for recording the program, depending on whether a prescribed similarity relation is found in the prescribed attribute values included in the pieces of information related to the programs, between the program of interest and the plurality of recorded programs and the programs to be recorded. By way of example, assume that in the home NW described above, the user instructs recording of a program from the shared recording requesting apparatus. It is highly possible that the information related to this program is similar to the pieces of information related to the plurality of recorded programs and the programs to be recorded by the recording apparatus owned by the user, as they both reflect the user's preferences. Therefore, upon reception of the search request from the recording requesting apparatus, it is highly likely that the recording apparatus owned by the user determines that it is suitable for recording the program and sends the notice to that effect to the recording requesting apparatus. Assume that the recording requesting apparatus selects a recording apparatus for recording the program from among the recording apparatuses notifying that they are suitable for recording the program. In such a situation, it is highly likely that the recording requesting apparatus selects the recording apparatus owned by the user. Accordingly, it is possible to select the recording apparatus owned by an individual as the recording apparatus for recording the program, without necessitating troublesome operations and works of individual authentication.

Preferably, the to-be-recorded program includes a reserved program of which recording is reserved. The recording apparatus further includes means for calculating, based on the prescribed attribute value included in each of the pieces of information related to the recorded and to-be-recorded programs stored in the recording information storage means, inclination related to the prescribed attribute. The first determining means includes second determining means, comparing the information related to the program included in the received search request with each of the pieces of information related to the recorded and to-be-recorded programs stored in the recording information storage means, and if the prescribed attribute value included in the information related to the program and the prescribed attribute value included in any of the pieces of information related to the recorded and to-be-recorded programs satisfy a prescribed similarity relation, for determining whether the recording apparatus is eligible for recording the program, in accordance with result of calculation of inclination related to the prescribed attribute by the calculating means.

The calculating means calculates the inclination toward a prescribed attribute, of the pieces of information related to each of the recorded and to-be-recorded programs. In connection with the prescribed attribute value, if a prescribed similarity relation is found between the information related to the program and any of the pieces of information related to the recorded or to-be-recorded programs, the second determining means determines whether or not the recording apparatus is suitable for recording the program, by comparing the calculated inclination toward the prescribed attribute and the prescribed attribute value.

The recording apparatus determines whether or not there is a prescribed similarity relation between the inclination of recording instruction and the inclination of recording of the recording apparatus, and based on the result of this determination, determines whether or not it is suitable for recording the program. The reason is as follows. If there is a prescribed similarity relation between the inclination of the recording instruction and the inclination of recording by the recording apparatus, it is highly likely that the recording apparatus is owned by the user who instructs recording. The result of calculation by the calculating means represents the inclination of recording by the recording apparatus. Here, as regards a prescribed attribute value, if the information related to the program is similar to any of the pieces of information related to the recorded and to-be-recorded programs, and if the prescribed attribute value meets the calculated inclination of recording by the recording apparatus, it means that a prescribed similarity relation exists between the inclination of the recording instruction and the inclination of recording by the recording apparatus. Specifically, assume that in connection with a prescribed attribute, information related to the program and a piece of information related to a certain recorded program both have the same value, and as regards the calculated prescribed inclination, most of the pieces of information related to the recorded and to-be-recorded programs include the same value. Then, it is natural to consider that a prescribed similarity relation exists between the inclination of the recording instruction and the inclination of recording by the recording apparatus. In the calculated inclination, if such a value is hardly included in the pieces of information related to the recorded and to-be-recorded programs, we can say that a prescribed similarity relation cannot be found between the inclination of the recording instruction and the inclination of recording by the recording apparatus.

Preferably, the recording apparatus further includes: program list information storage means, receiving broadcast signals, processing program list information included in the broadcast signals, for storing the program list information; and recommended program extracting means for extracting, in accordance with the result of calculation of inclination related to the prescribed attribute calculated by the calculating means, a program of which recording is recommended to the user from programs of which related pieces of information are included in the program list information stored in the program list information storage means. The to-be-recorded programs include a reserved program of which recording is reserved and the recommended program extracted by the recommended program extracting means. The first determining means further includes means for determining whether or not the recommended program or programs extracted by the recommended program extracting means include the same program as the program, and if the recommended program or programs include the same program as the program, for determining that the recording apparatus is eligible for recording the program, and otherwise, for causing the second determining means to execute the process.

The recommended program extracting means extracts, following the inclination of recording by the recording apparatus, a recommended program of which recording is recommended to the user, from among the programs of which related pieces of information are stored in the stored program list information. If the program of interest is included in the extracted recommended program, the first determining means determines that the recording apparatus is suitable for recording the program. The recommended program is extracted following the inclination of recording by the recording apparatus. Therefore, if the program of interest is included in the recommended programs, it means that the value of prescribed attribute included in the information related to the program matches the inclination of recording by the recording apparatus. Accordingly, the recording apparatus determines that a prescribed similarity relation exists between the inclination of recording instruction and the inclination of recording by the recording apparatus.

Preferably, the notifying means includes means for providing, if it is determined by the first determining means that the recording apparatus is eligible for recording the program, a notice that the apparatus is eligible for recording the program, and otherwise, a notice that the recording apparatus in ineligible for recording the program, to the recording requesting apparatus that transmitted the search request.

In connection with a prescribed attribute value, if there is a prescribed similarity relation between the information related to the program of interest and any of the pieces of information related to the recorded and to-be-recorded programs, the recording apparatus determines that the recording apparatus is suitable for recording the program and, by the notifying means, notifies the recording requesting apparatus as the transmission source of the search request that the recording apparatus is suitable for recording the program. Otherwise, it determines that the recording apparatus is not suitable for recording the program, and by the notifying means, transmits a notice that the recording apparatus is not suitable for recording the program, to the recording requesting apparatus.

Preferably, the prescribed attribute value includes a word.

Preferably, the prescribed attribute value includes a word sequence indicating genre of a program, a word sequence indicating a keyword, or a word sequence indicating a performer, or an arbitrary combination of these.

If the information related to the program and the words representing program genre, keywords, performers and the like included in any of the pieces of information related to the recorded and to-be-recorded programs satisfy a prescribed similarity relation, the recording apparatus determines that the recording apparatus is suitable for recording the program. Otherwise, the recording apparatus determines that it is not suitable for recording the program.

Preferably, the recording apparatus further includes attribute changing means for changing the prescribed attribute value in accordance with a user operation.

Preferably, the recording apparatus further includes similarity relation setting changing means for changing setting related to the prescribed similarity relation in accordance with a user operation.

In the present recording apparatus, the user can change the method and criterion for determining whether or not the recording apparatus is suitable for recording the program.

Preferably, the recording information includes pieces of information related to a plurality of recorded and to-be-recorded programs. The determining means includes: similarity degree calculating means for calculating degree of similarity between the information related to the program specified by the received search request and each of the pieces of information related to the recorded and to-be-recorded programs; and first determining means for determining, if any of the degrees of similarity calculated by the similarity degree calculating means is equal to or higher than a predetermined threshold value, the recording apparatus to be eligible for recording the program.

The similarity degree calculating means calculates the degree of similarity between the information related to the program and the pieces of information related to the recorded and to-be-recorded programs. If the degree of similarity between the information related to the program and any of the pieces of information related to the recorded and to-be-recorded programs is equal to or higher than a predetermined threshold value, the recording apparatus is determined to be suitable for recording the program. If such conditions are not satisfied by any of the pieces of information related to the recorded and to-be-recorded programs, the recording apparatus is determined to be not suitable for recording the program.

In the example of the home NW described above, it is most likely that the inclination of the recording information of the recording apparatus owned by the user is similar to the inclination of recording instruction made by the user, as compared with other recording apparatuses on the home NW. Therefore, it is considered that the pieces of information related to the recorded and to-be-recorded programs in the recording apparatus owned by the user are similar to the information related to the program of interest and, hence, have relatively high degree of similarity. Accordingly, it is highly likely that the recording apparatus owned by the user determines it is suitable for recording the program and so notifies the shared recording requesting apparatus, and that the recording requesting apparatus determines the recording apparatus owned by the user to be the recording apparatus for recording the program. As a result, it is possible to select the recording apparatus owned by an individual without necessitating troublesome operations and works of selecting the recording apparatus.

Preferably, the information related to the program and each of the pieces of information related to the recorded and to-be-recorded programs include a character string.

The recording apparatus calculates degree of similarity between the character strings included in the information related to the program and the character strings included in each of the pieces of information related to the recorded and to-be-recorded programs, and if any of the degrees is equal to or higher than a predetermined threshold value, the recording apparatus determines that it is suitable for recording the program and so notifies to the recording requesting apparatus. Otherwise, the recording apparatus determines that it is not suitable for recording the program, and so notifies to the recording requesting apparatus.

Preferably, the recording apparatus further includes similarity degree setting changing means for changing settings related to a method of calculating the degree of similarity by the similarity degree calculating means and related to the predetermined threshold value, in accordance with a user operation.

In the recording apparatus, it is possible for the user to change the method and criterion for determining whether the recording apparatus is suitable for recording the specific program or not.

According to a third aspect, the present invention provides a recording requesting apparatus connected to a network having a recording apparatus or recording apparatuses connected thereto. The recording requesting apparatus includes: broadcast signal processing means, receiving broadcast signals, for executing a process for decoding and outputting video and audio signals included in the broadcast signals of a designated channel and processing and outputting a program list information included in the broadcast signals; program list information storage means for storing the program list information output from the broadcast signal processing means; display means for displaying either or both of the video signal output from the broadcast signal processing means and the program list information read from the program list information storage means, in accordance with a user instruction; recording apparatus detecting means for detecting a recording apparatus or recording apparatuses connected to the network; means for obtaining information related to a specific program from the program list information stored in the program list information storage means; and recording information transmission requesting means for transmitting a transmission request related to recording information through the network to the recording apparatus or recording apparatuses detected by the recording apparatus detecting means. The recording information includes recording history and recording plan by the recording apparatus. The recording requesting apparatus further includes: recording apparatus selecting means, comparing the information related to the program obtained by the obtaining means with each piece of recording information of the recording apparatus received from the recording apparatus or recording apparatuses in response to the transmission request from the recording information transmission request, for selecting a recording apparatus for recording the program in accordance with the result of comparison; and recording request transmitting means for transmitting a recording request related to recording of the program, to the recording apparatus selected by the recording apparatus selecting means.

In the recording requesting apparatus, the obtaining means obtains information related to the specific program from the program list information stored in the program list storage means. The recording information transmission requesting means sends a transmission request, requesting transmission of recording information including recording history and recording plan in each recording apparatus, to each of the recording apparatuses on the network. The recording apparatus determining means compares the obtained information related to the program with the recording information transmitted from each of the recording apparatuses, and selects the recording apparatus to record the program, in accordance with the result of comparison. The recording process requesting means transmits a recording request related to recording of the program to the selected recording apparatus.

In the recording requesting apparatus, the recording apparatus selecting means compares the information related to the program with the recording information collected from the recording apparatuses on the network, and based on the result of comparison, selects a recording apparatus suitable for recording the program. By way of example, in the home NW described above, it is most likely that the inclination of the recording information of the recording apparatus owned by the user is similar to the inclination of recording instruction made by the user, as compared with other recording apparatuses on the home NW. If the recording apparatus for recording the program is selected based on the degree of similarity, it is highly likely that the recording apparatus selecting means selects the recording apparatus owned by the user to be the recording apparatus for recording the program. As a result, it is possible to select the recording apparatus owned by an individual without necessitating troublesome operations and works of selecting the recording apparatus.

According to a fourth aspect, the present invention provides a recording apparatus connected to a network having at least one recording requesting apparatus connected thereto, including: recording information storage means for storing recording information including recording history or/and recording plan by the recording apparatus; means, responsive to a transmission request for recording information transmitted from the recording requesting apparatus, for transmitting the recording information stored in the recording information storage means; and recording process executing means, responsive to a request related to recording of a program transmitted from the recording requesting apparatus, for executing a process related to recording of the program.

If a transmission request requesting the recording information is received from the recording requesting apparatus, the recording apparatus transmits the recording information including the recording history and the recording plan to the recording requesting apparatus that transmitted the transmission request. When recording requesting apparatus compares the recording information transmitted from each of the recording apparatuses with the information related to the program, selects the recording apparatus and transmits a request related to recording of the program, the recording apparatus executes the process related to recording of the program.

According to a fifth aspect, the present invention provides a system including at least one recording requesting apparatus and a plurality of recording apparatuses connected to a network. The recording requesting apparatus included in the system includes: broadcast signal processing means, receiving broadcast signals, for executing a process for decoding and outputting video and audio signals included in the broadcast signals of a designated channel and processing and outputting a program list information included in the broadcast signals; program list information storage means for storing the program list information output from the broadcast signal processing means; display means for displaying either or both of the video signal output from the broadcast signal processing means and the program list information read from the program list information storage means, in accordance with a user instruction; recording apparatus detecting means for detecting a recording apparatus or recording apparatuses connected to the network; and search request transmitting means, for obtaining information related to a specific program from the program list information stored in the program list information storage means, and for transmitting a search request related to the program through the network to the recording apparatus or recording apparatuses detected by the recording apparatus detecting means. The search request includes information related to the program. The recording apparatus included in the system includes: recording information storage means for storing recording information including either or both of recording history and recording plan of the recording apparatus; determining means, comparing the information related to the program specified by the search request received from the recording requesting apparatus with the recording information stored in the recording information storage means, for determining whether or not the recording apparatus is eligible for recording the program, in accordance with the result of comparison; and notifying means for providing a notice in accordance with the result of determination by the determining means, to the recording requesting apparatus that transmitted the search request. The recording requesting apparatus included in the system further includes: recording apparatus selecting means for selecting a recording apparatus for recording the program, based on notices from the plurality of recording apparatuses; and recording request transmitting means for transmitting a request related to recording of the program, to the recording apparatus selected by the recording apparatus selecting means. The recording apparatus included in the system further includes recording process executing means, responsive to the request related to recording of the program transmitted from the recording requesting apparatus, for executing a process related to recording of the program.

In the recording requesting apparatus of the present system, of the broadcast signals received by the broadcast signal processing means, video and audio signals are decoded and output, and displayed on the display means in accordance with a user instruction. Of the broadcast signals, the program list information is processed and stored in the program list information storage means. Upon instruction by the user, the program list information is read from the program list storage means, and displayed on the display means. The recording apparatus detecting means detects recording apparatuses connected to the network. The search request transmitting means obtains information related to a specific program, from the stored program list information. Further, the search request transmitting means transmits a search request including the obtained information related to the program, to the connected recording apparatuses.

In response to reception of the search request from the recording requesting apparatus, the recording apparatus compares the information related to the program included in the search request with the recording information stored in the recording information storage means, and based on the result of comparison, determines whether or not the recording apparatus is suitable for recording the program. The notifying means transmits to the recording requesting apparatus that transmitted the search request a notice in accordance with the result of determination by the determining means.

Based on the notices transmitted from the recording apparatuses, the recording apparatus selecting mean of the recording requesting apparatus selects a recording apparatus for recording the program. The recording requesting apparatus transmits the request related to recording of the program to the selected recording apparatus. Receiving the request related to recording of the program from the recording requesting apparatus, the recording process executing means executes processes related to recording of the program.

The recording requesting apparatus selects a recording apparatus suitable for recording the program from among the recording apparatuses on the network. The selection is made based on the contents of notices returned from the recording apparatuses in accordance with the information related to the program transmitted from the recording requesting apparatus. The notice follows the following determination in the recording apparatus. Specifically, the recording apparatus compares the information related to the program with either of or both of the recording history and recording plan, and determines whether or not the recording apparatus is suitable for recording the program based on the result of comparison.

By way of example, assume that in the home NW described above, the user instructs recording of a program from the shared recording requesting apparatus. It is highly possible that the information related to this program is similar to the recording information of the recording apparatus owned by the user, as they both reflect the user's preferences. It is most likely that either of or both of the recording history and recording plan of the recording apparatus owned by the user are similar to the information related to the program, as compared with other recording apparatuses on the home NW. If it is the case that whether or not the recording apparatus is suitable for recording the program is determined based on the degree of similarity between the information related to the program and either one of or both of the recording history and the recording plan, it is highly likely that the recording apparatus owned by the user determines that it is suitable for recording the program. Therefore, it is highly likely that based on the notice from the recording apparatus owned by the user, the recording requesting apparatus selects the recording apparatus owned by the user to be the recording apparatus for recording the program.

As a result, it is possible to select the recording apparatus owned by an individual without necessitating troublesome operations and works of selecting the recording apparatus at the time of recording a program.

According to a sixth aspect, the present invention provides a method of selecting a recording apparatus in a system including at least one recording requesting apparatus and a plurality of recording apparatuses connected to a network. The recording requesting apparatus included in the system includes: program list information storage means, receiving broadcast signals, processing program list information included in the broadcast signals, for storing the program list information; recording apparatus detecting means for detecting the recording apparatuses connected to the network; and search request transmitting means, obtaining information related to a specific program from the program list information stored in the program list information storage means, for transmitting, through the network, a search request related to the program to the recording apparatuses detected by the recording apparatus detecting means. The search request includes information related to the program. The recording apparatus included in the system includes: recording information storage means for storing recording information including either or both of recording history and recording plan of the recording apparatus; determining means, comparing the information related to the program specified by the search request received from the recording requesting apparatus with the recording information stored in the recording information storage means, for determining whether or not the recording apparatus is eligible for recording the program, in accordance with the result of comparison; and notifying means for providing a notice in accordance with the result of determination by the determining means, to the recording requesting apparatus that transmitted the search request. The recording requesting apparatus included in the system further includes: recording apparatus selecting means for selecting a recording apparatus for recording the program, based on notices from the plurality of recording apparatuses; and recording request transmitting means for transmitting a request related to recording of the program, to the recording apparatus selected by the recording apparatus selecting means. The recording apparatus included in the system further includes recording process executing means, responsive to the request related to recording of the program transmitted from the recording requesting apparatus, for executing a process related to recording of the program. The recording apparatus selecting method includes: program information obtaining step of the program information transmitting means obtaining information related to a specific program from the program list information stored in the program list information storage means; program information transmitting step of the program information transmitting means transmitting a search request related to the program to the recording apparatuses detected by the recording apparatus detecting means, through the network; determining step of the determining means of comparing, in response to reception of the search request transmitted from the recording requesting apparatus by the recording apparatus, the information related to the program specified by the search request with the recording information stored in the recording information storage means, and in accordance with the result of determination, determining whether or not the recording apparatus is eligible for recording the program; notifying step of the notifying means of transmitting a notice in accordance with the result of determination at the determining step, to the recording requesting apparatus that transmitted the search request; recording apparatus selecting step of the recording apparatus selecting means selecting, based on the notices from the plurality of recording apparatuses at the notifying step, a recording apparatus for recording the program; recording process request transmitting step of the recording process request transmitting means transmitting a request related to recording of the program to the recording apparatus selected at the recording apparatus selecting step; and the recording process executing means executing the process related to recording of the program, in response to the request related to recording of the program transmitted from the recording requesting apparatus at the recording process request transmitting step.

In the method of selecting a recording apparatus, in the recording requesting apparatus, the information of a specific program is obtained from the program list information stored in the program list storage means. The search request transmitting means transmits the search request related to the program including the obtained information related to the program, to the recording apparatuses on the network. Receiving this request, in the recording apparatus, the determining means compares the transmitted information related to the program with the recording information including either one of or both of the recording history and the recording plan. In accordance with the result of comparison, the determining means determines whether the recording apparatus is suitable for recording the program. The notifying means transmits a notice in accordance with the result of determination by the determining means to the recording requesting apparatus as the source of transmission of the search request. Based on the notice from the recording apparatus, the recording requesting apparatus selects a recording apparatus suitable for recording the program, from among the recording apparatuses on the network. The recording request transmitting means transmits a request related to recording of the program to the selected recording apparatus. Receiving the request related to recording of the program, recording apparatus executes processes related to recording of the program.

The recording requesting apparatus selects a recording apparatus suitable for recording the program from among the recording apparatuses on the network. The selection is made based on the contents of notices returned from the recording apparatuses in accordance with the information related to the program transmitted from the recording requesting apparatus. The notice follows the following determination in the recording apparatus. Specifically, the recording apparatus compares the information related to the program with either of or both of the recording history and recording plan, and determines whether or not the recording apparatus is suitable for recording the program based on the result of comparison. By way of example, in the home NW described above, the information related to this program and the recording information of the recording apparatus owned by the user both reflect the user's preferences and, therefore, it is most likely that either of or both of the recording history and recording plan of the recording apparatus owned by the user are similar to the information related to the program, as compared with other recording apparatuses on the home NW. If it is the case that whether or not the recording apparatus is suitable for recording the program is determined based on the degree of similarity between the information related to the program and either one of or both of the recording history and the recording plan, it is highly likely that the recording apparatus owned by the user determines that it is suitable for recording the program. Therefore, it is highly likely that based on the notice from the recording apparatus owned by the user, the recording requesting apparatus selects the recording apparatus owned by the user to be the recording apparatus for recording the program. As a result, it is possible to select the recording apparatus owned by an individual without necessitating troublesome operations and works of selecting the recording apparatus.

According to a seventh aspect, in a recording requesting apparatus connected to a network having a recording apparatus or recording apparatuses connected thereto, including: program list information storage means, receiving broadcast signals, processing program list information included in the broadcast signals, for storing the program list information; communication means for communicating with the recording apparatus through the network; and a computer capable of reading the program list information stored in the program list information storage means and capable of controlling the communication means; the present invention provides a computer program executed by the computer for selecting a recording apparatus suitable for recording a specific program. The computer program causes the computer to function as: recording apparatus detecting means for detecting the recording apparatus or recording apparatuses through the communication means; program information obtaining means for obtaining information related to the program from the program list information stored by the program list information storage means; search request transmitting means for transmitting, to the recording apparatus or recording apparatuses detected by the recording apparatus detecting means, a search request related to the program including information related to the program, by controlling the communication means; recording apparatus selecting means for selecting a recording apparatus for recording the program, based on a notice or notices transmitted from the recording apparatus or recording apparatuses in response to the search request from the search request transmitting means and received by the communication means; and recording request transmitting means for transmitting a recording request related to recording of the program to the recording apparatus selected by the recording apparatus selecting means by controlling the communication means.

In the present computer program, the recording apparatus detecting means detects recording apparatuses connected to the network. The search request transmitting means obtains information related to a specific program from stored program list information. Further, the search request transmitting means transmits the search request related to the program including the obtained information related to the program, to the recording apparatuses on the network. Based on notices from recording apparatuses transmitted in response to the search request, the recording apparatus selecting means selects a recording apparatus for recording the program. The recording request transmitting means transmits a recording request related to recording of the program, to the selected recording apparatus.

The present computer program selects a recording apparatus suitable for recording the specific program from among the recording apparatuses on the network. The selection is made based on the contents of notices returned from the recording apparatuses in accordance with the information related to the program transmitted from the search request transmitting means. The contents of notices are in accordance with the result of search of the information in the recording apparatuses, using the information related to the program as a key.

By way of example, assume that in the home NW described above, the user instructs recording of a program from the shared recording requesting apparatus. It is highly likely that the information related to the program and the information in the recording apparatus owned by the user reflect preferences of the user. Therefore, the information in the recording apparatus owned by the user has the highest possibility to present matching or closely matching result in the search for the information related to the program, as compared with other recording apparatuses on the network. Consequently, the notice from the recording apparatus owned by the user highly likely reflects the matching or closely matching results of search. If it is the case that the present computer program selects a recording apparatus that gives a notice reflecting the matching or closely matching result of search to be the recording apparatus for recording the program, it is highly likely in the example above that the present computer program selects the recording apparatus owned by the user.

From the foregoing, according to the computer program, it is possible to select the recording apparatus owned by an individual without necessitating troublesome operations and works of selecting the recording apparatus.

According to an eighth aspect, in a recording apparatus connected to a network having at least one recording requesting apparatus, wherein the recording requesting apparatus transmits a search request related to a specific program, including information related to the program, to the recording apparatus, and wherein the recording apparatus includes recording information storage means for storing recording information including either or both of recording history and recording plan of the recording apparatus, communication means for communication with the recording requesting apparatus through the network, recording process executing means for executing a process related to recording of the program, and a computer capable of reading recording information stored in the recording information storage means, and capable of controlling the communication means and the recording process executing means, the present invention provides a computer program executed by the computer, for performing a process related to recording of the program. The computer program causes the computer to function as: determining means, responsive to the communication means receiving the search request from the recording requesting apparatus, for comparing the information related to the program specified by the search request with the recording information stored in the recording information storage means, and for determining whether or not the recording apparatus is eligible for recording the program in accordance with the result of comparison; notifying means for transmitting a notice in accordance with the result of determination by the determining means to the recording requesting apparatus that transmitted the search request, by controlling the communication means; and means for controlling the recording process executing means to function as means for executing a process related to recording of the program, in response to the communication means receiving a request related to recording of the program transmitted from the recording requesting apparatus.

The present computer program compares the information related to the program with either one of or both of the recording history and the recording plan, and determines whether or not the recording apparatus is suitable for recording the program based on the result of comparison. By way of example, assume that in the home NW described above, the information in the recording apparatus owned by the user has the highest possibility to present matching or closely matching result in the search for the information related to the program, as compared with other recording apparatuses on the network. In this manner, the computer program provides notices and the like that reflect the degree of similarity between the information related to the program and the information in the recording apparatuses on the network. If it is the case that the recording apparatus for recording the program is selected based on the degree of similarity, it is highly likely that the recording apparatus owned by the user is selected to be the recording apparatus for recording the program. From the foregoing, it is possible to select the recording apparatus owned by an individual without necessitating troublesome operations and works of selecting the recording apparatus.

### EFFECTS OF THE INVENTION

As described above, in the present system, for recording a specific program, information related to the program is compared with recording history and recording plan of each of a plurality of recording apparatuses on the network, and based on the result of comparison, the recording apparatus for executing recording of the program is selected. Therefore, by the present system, it is possible to select the recording apparatus suitable for executing recording of the program, without necessitating troublesome operations and works of selecting the recording apparatus.

### BRIEF DESCRIPTION OF THE DRAWINGS

FIG. 1 is a schematic block diagram of a program recording system 10 in accordance with a first embodiment of the present invention.

FIG. 2 is a schematic functional block diagram of a first program viewing apparatus 31 shown in FIG. 1.

FIG. 3 shows an example of program information stored in a program information storage unit 121 shown in FIG. 2.

FIG. 4 shows an example of home NW apparatus information stored in a home NW setting storage unit 123 shown in FIG. 2.

FIG. 5 is a schematic functional block diagram of a first recording apparatus 32 shown in FIG. 1.

FIG. 6 shows an example of preference information calculated by a recommended program extracting unit 213 shown in FIG. 5.

FIG. 7 shows a list of programs of which recording is automatically reserved and recommended programs.

FIG. 8 is a flowchart of a main program for selecting a recording apparatus on home NW and executing recording of a program, executed by a home NW recording apparatus selection control unit 115 shown in FIG. 1.

FIG. 9 shows an exemplary image displayed on a display unit 119 shown in FIG. 2, at S106 of FIG. 8.

FIG. 10 is a flowchart of a program for notifying state of recording or determination result as to whether the recording apparatus is eligible, to the program viewing apparatus, executed by the reserved program/recommended program searching unit 215 shown in FIG. 5.

FIG. 11 is a flowchart of a program for the determination at S203 of FIG. 10.

FIG. 12 is a flowchart of a program for the determination at S203 of FIG. 10.

FIG. 13 shows an example of a time table of programs viewed on program viewing apparatus 31 shown in FIG. 1.

FIG. 14 is a flowchart of a program for selecting a recording apparatus on the home NW and allocating it to all programs included in EPG information, executed by home NW recording apparatus selection control unit 115 in the program recording system in accordance with a second embodiment of the present invention.

FIG. 15 is a flowchart of a program for executing recording by the recording apparatus allocated for the program, executed by home NW recording apparatus selection control unit 115 in accordance with a recording instruction by a user.

FIG. 16 is a flowchart of a program for selecting and storing a recording apparatus suitable for recording a program, executed by home NW recording apparatus selection control unit 115 in the program recording system in accordance with a third embodiment of the present invention.

FIG. 17 is a flowchart of a program for selecting a recording apparatus suitable for recording a program and causing the recording apparatus to execute recording, executed by home NW recording apparatus selection control unit 115 in the program recording system in accordance with a fourth embodiment of the present invention.

FIG. 18 is a flowchart of a process executed in response to a determination of NO at S374 of FIG. 17.

FIG. 19 is a flowchart of a program for selecting a recording apparatus suitable for recording a program and causing the recording apparatus to execute recording, executed by home NW recording apparatus selection control unit 115 in the program recording system in accordance with a fifth embodiment of the present invention.

### DESCRIPTION OF THE REFERENCE SIGNS

10 program recording system, 30 home NW, 31, 33 program viewing apparatus, 32, 34 recording apparatus, 40 remote controller, 100, 200 antenna, 101, 201 tuner, 102, 202 IP communication unit, 103, 203 user operation unit, 110, 210 processing unit, 111, 211 video/audio decoding unit, 112, 212 program information extracting unit, 113 channel selection information obtaining unit, 114 home NW apparatus detecting unit, 115 home NW recording apparatus selection control unit, 119 display unit, 120 audio output unit, 121, 221 program information storage unit, 123 home NW setting storage unit, 213 recommended program extracting unit, 214 recording schedule generating unit, 215 reserved program/recommended program searching unit, 216 recording unit, 217 content management unit, 220 video/audio external output unit, 222 recommended program/recording schedule storage unit, 223 content storage unit.

### BEST MODES FOR CARRYING OUT THE INVENTION

### First Embodiment

The program recording system in accordance with a first embodiment of the present invention relates to the environment of home NW described above. In the present system, if a user instructs recording of a program that he/she is viewing to a program viewing apparatus, the program viewing apparatus transmits, through the home NW, a search request using information related to the program (program title, genre, keyword, performer etc.) as a key, to recording apparatuses included in the system. Receiving the search request related to the program, each recording apparatus transmits information indicating whether or not the recording apparatus is suitable for recording the program to the program viewing apparatus, depending on whether or not a prescribed similarity relation is found between the information related to the program and the recording history and recording plan of the apparatus itself. Receiving the signals, the program viewing apparatus determines which recording apparatus should be used for recording, and instructs recording of the program to the corresponding recording apparatus.

Among the recording apparatuses included in the system, the recording apparatus owned by the user has the highest possibility that the recording history and the recording plan of the apparatus have similarity to the inclination of user instruction instructing recording. Therefore, the recording apparatus owned by the user is often selected from among the plurality of recording apparatuses, by the process described above.

In the following, if a recording apparatus is determined to be suitable for recording a program of interest, the recording apparatus will be denoted as “eligible” and otherwise, “ineligible.”

—Configuration—

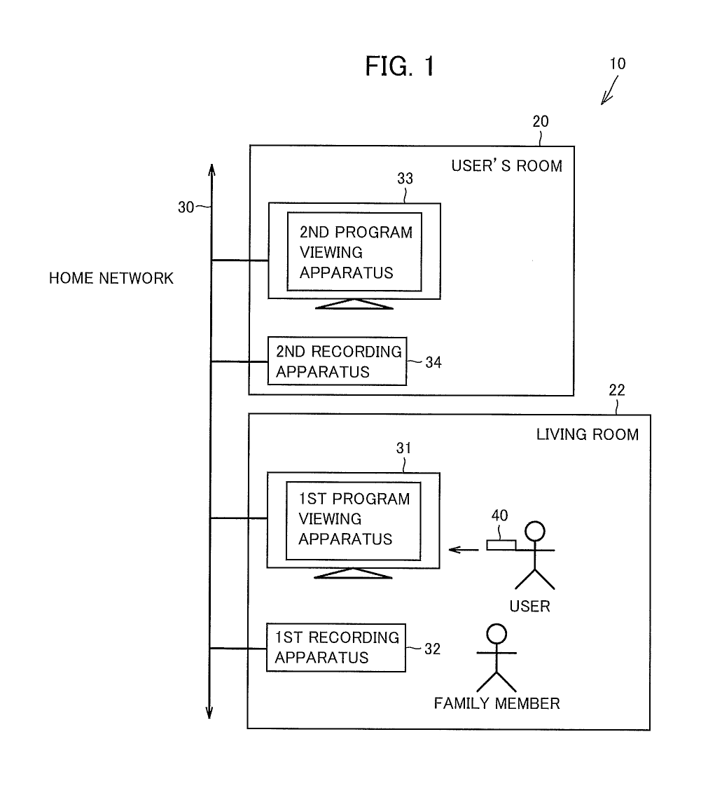

FIG. 1 is a schematic diagram illustrating program recording system 10 in accordance with the present embodiment. Referring to FIG. 1, program recording system 10 includes: a first program viewing apparatus 31 and a first recording apparatus 32 placed in a living room 22 and shared by the user's family; a second program viewing apparatus 33 and a second recording apparatus 34 placed in a personal room of the user, and a home NW 30 connected to the first and second program viewing apparatuses 31 and 33 and to the first and second recording apparatuses 32 and 34.

Here, it is assumed that the first and second program viewing apparatuses 31 and 33 are both digital TVs having a network function and a digital media player (DMP) function, and that home NW 30 is wired LAN. Further, it is assumed that the first program viewing apparatus 31 is operated by an instruction from a remote controller 40, which is an infrared remote controller.

The first and second program viewing apparatuses 31 and 33 both function as recording requesting apparatuses that request recording apparatuses connected to home NW 30 for recording of a specific program.

It is assumed that the first and second recording apparatuses 32 and 34 are both HDD (Hard Disc Drive) recorders with a tuner for terrestrial digital broadcast, having the network function and a digital media server (DMS) function.

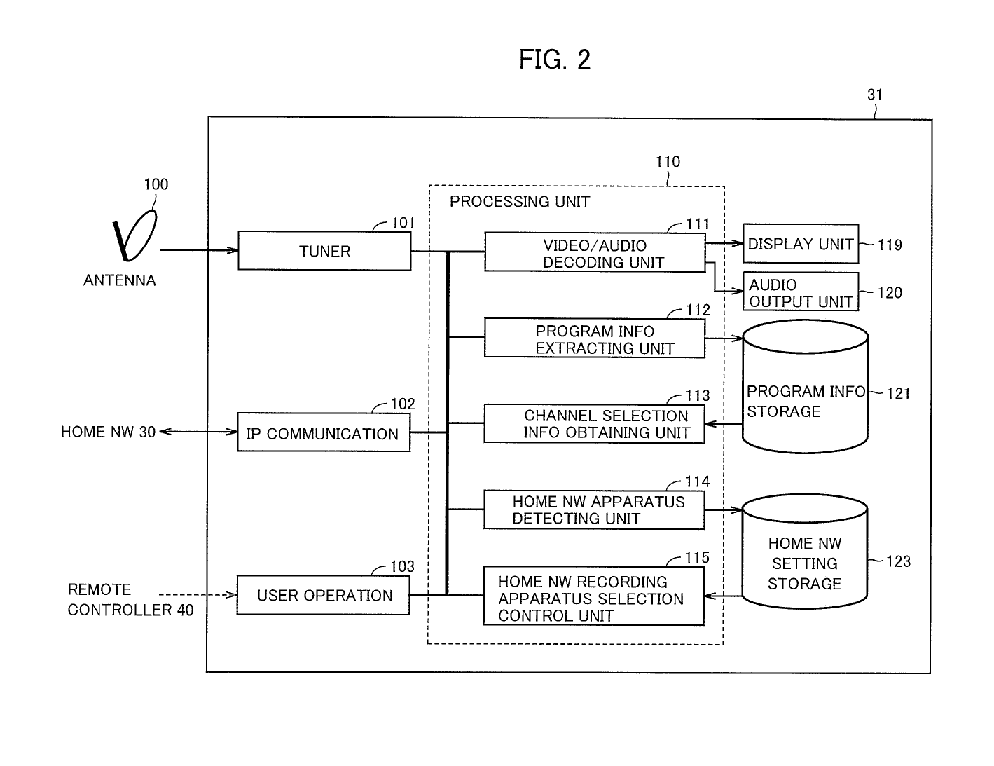

FIG. 2 is a block diagram showing schematic functional configuration of the first program viewing apparatus 31. The first and second program viewing apparatuses 31 and 33 have the same configuration. Therefore, only the configuration of the first program viewing apparatus 31 will be described in the following.

Referring to FIG. 2, the first program viewing apparatus 31 includes: an antenna 100 for receiving digital television broadcast signals; a digital broadcast frontend processing tuner (hereinafter referred to as a “tuner”) 101, connected to receive the digital television broadcast signals received by antenna 100, for selecting digital broadcast signals of a channel designated by an externally applied channel selection signal; an IP communication unit 102 connected to home NW 30, for communication with other apparatuses included in program recording system 10 in accordance with IP (Internet Protocol); and a user operation unit 103 for receiving an operation control instruction from the user and transmitting an operation control signal to a related component.

The operation control includes control related to the first program viewing apparatus 31 such as channel/input selection, volume increase/decrease, and recording instruction. Here, it is assumed that user operation unit 103 receives a user instruction from remote controller 40.

The first program viewing apparatus 31 further includes a processing unit 110, connected to tuner 101, IP communication unit 102 and user operation unit 103, performing: reception of digital television broadcast signals output from tuner 101; signal processing for outputting digital broadcast signals of the channel selected by the user included in the digital television broadcast signals and outputting an electronic program guide (hereinafter referred to as “EPG”); selection of a recording apparatus in view of recording history and the like, in response to a program recording instruction, and issuing an instruction to record to the selected recording apparatus; and various general functions of a program viewing apparatus. Processing unit 110 is substantially implemented by a computer system including a CPU (Central Processing Unit), a memory, an I/O (input/output) port and the like and control software executed by the computer system.

Processing unit 110 includes: a video/audio decoding unit 111 decoding AV information from a stream output from tuner 101 and outputting video signals and audio signals, respectively; a program information extracting unit 112 for extracting EPG information included in SI (Service Information: program sequence information)/PSI (Program Specific Information: information for specifying program) of the stream output from tuner 101; a channel selection information obtaining unit 113 for obtaining program information related to the stream that is currently viewed, from a program information storage unit, which will be described later; a home NW apparatus detecting unit 114, responsive to IP communication unit 102 receiving a signal indicating connection or detachment of an apparatus to/from home NW 30, for detecting an apparatus connected to home NW by UPnP (Universal Plug and Play) and obtaining information related to the connected apparatus; and a home NW recording apparatus selection control unit 115, responsive to a recording instruction made by the user, for reading information of apparatuses connected to the home NW from a home NW setting storage unit, which will be described later, and executing a program as will be described later to select a recording apparatus most suitable for recording the program from among the recording apparatuses connected to home NW 30 and to instruct the recording apparatus to record. Video/audio decoding unit 111, program information extracting unit 112, channel selection information obtaining unit 113, home NW apparatus detecting unit 114 and home NW recording apparatus selection control unit 115 can communicate with each other.

The first program viewing apparatus 31 further includes: a display unit 119, connected to processing unit 110, receiving outputs from video/audio decoding unit 111, for displaying video images of a program broadcast on the channel selected by the user; an audio output unit 120, connected to processing unit 110, receiving outputs from video/audio decoding unit 111, for outputting sound of the program broadcast on the channel selected by the user; a program information storage unit 121, connected to processing unit 110, for storing EPG information output from program information extracting unit 112; and a home NW setting storage unit 123, connected to processing unit 110, for storing information related to apparatuses connected to home NW 30 in program recording system 10. Program information storage unit 121 and home NW setting storage unit 123 are substantially a HDD (Hard Disc Drive).

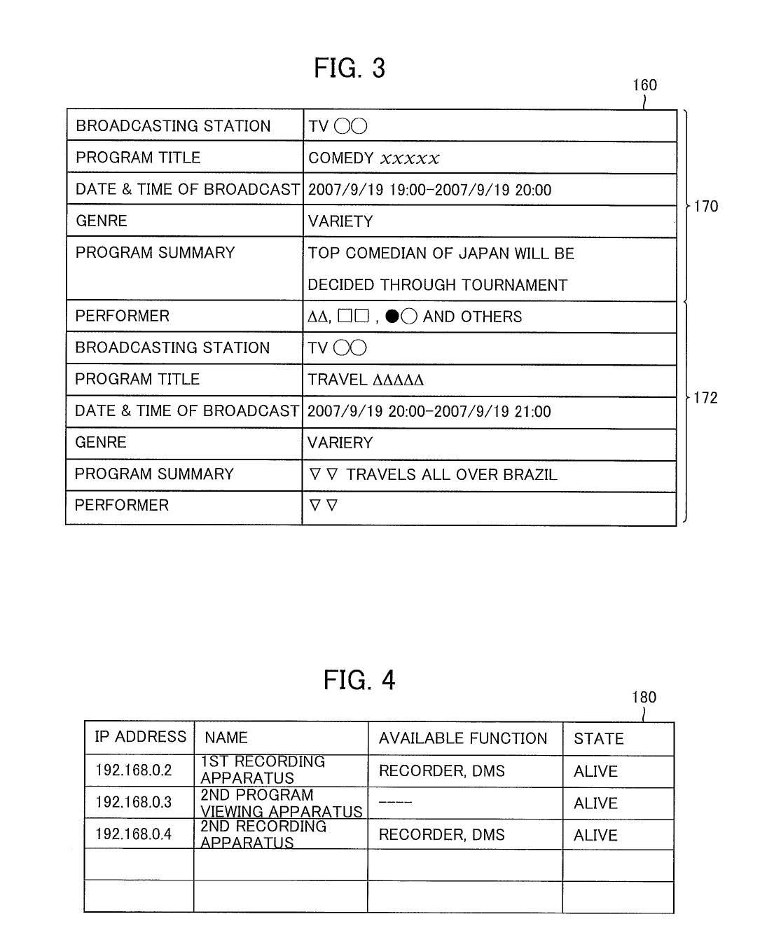

FIG. 3 shows an example of program information extracted by program information extracting unit 112 and stored in program information storage unit 121 from the digital television broadcast signals output from tuner 101, in the first program viewing apparatus 31 shown in FIG. 2. Referring to FIG. 3, program information 160 includes pieces of information related to programs viewed on the first program viewing apparatus 31, grouped program by program. Program information 160 includes pieces of information related to program title, date and time of broadcast, genre, program summary, and performer. Here, program information 160 includes program information 170 related to a program “Comedy Show xxxxx” and program information 172 related to a program “Travel ΔΔΔΔΔ.”

FIG. 4 shows an example of home NW apparatus information, detected by home NW apparatus detecting unit 114 and stored in home NW setting storage unit 123, in response to reception of a signal indicating a change in the state of connection of home NW 30 from IP communication unit 102, in the first program viewing apparatus 31 shown in FIG. 2.

Referring to FIG. 4, home NW apparatus information 180 is given as a table with each row representing pieces of information as a set related to each apparatus connected to home NW 30. Home NW apparatus information 180 includes, for each apparatus, an IP address column representing the IP address of the apparatus; a name column representing the apparatus name; an available function column representing a function or functions related to program recording available in the apparatus; and a state column indicating whether or not the apparatus is powered on and capable of receiving any instruction from any other apparatus. For each apparatus, the state column is set to “Alive” if it is powered on and to “Dead” if it is powered off.

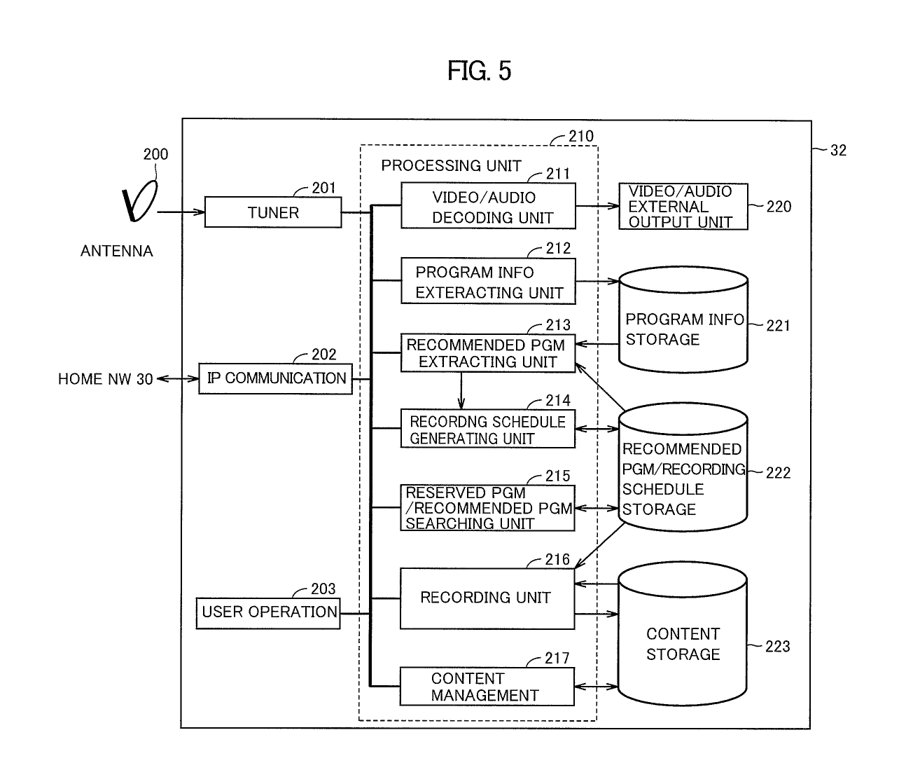

FIG. 5 is a block diagram showing a schematic functional configuration of first recording apparatus 32. The first and second recording apparatuses 32 and 34 have the same configuration. Therefore, only the configuration of first recording apparatus 32 will be described in the following.

Referring to FIG. 5, the first recording apparatus 32 has a configuration similar to the first program viewing apparatus 31. Specifically, the first recording apparatus 32 includes an antenna 200, an IP communication unit 202, and a user operation unit 203 similar to antenna 100, IP communication unit 102 and user operation unit 103 shown in FIG. 2. The configuration of first recording apparatus 32 is different from that of first program viewing apparatus 31 in that, in place of tuner 101, processing unit 110, display unit 119, audio output unit 120, program information storage unit 121 and home NW setting storage unit 123, it includes a tuner 201, a processing unit 210, a video/audio external output unit 220, a program information storage unit 221, a recommended program/recording schedule storage unit 222 and content storage unit 223.

The recommended program refers to a program the first recording apparatus 32 recommends the user to record, based on preference information related to recording by the first recording apparatus 32, as will be described later. Details of the recommended program and the preference information will be described later.

Tuner 201 is connected to receive digital television broadcast signals received by antenna 200, and selects and outputs digital broadcast signals of a channel designated by a channel selection signal applied in accordance with an instruction from a recording unit, which will be described later.

Processing unit 210 is connected to tuner 201, IP communication unit 202, user operation unit 203, video/audio external output unit 220, program information storage unit 221, recommended program/recording schedule storage unit 222 and content storage unit 223, and performs: reception of a stream output from tuner 201; signal processing for outputting the stream; when a search request related to recording is issued, for example, by the first program viewing apparatus 31, execution of a program for transmitting a result of determination as to whether the state of recording of the first recording apparatus 32 is eligible for recording the corresponding program, to the program viewing apparatus that transmitted the EPG information; and processes for realizing general functions of a recording apparatus. Processing unit 210 is substantially realized by a computer system including a CPU, a memory, an IO and the like and control software executed by the computer system.

Processing unit 210 includes: a video/audio decoding unit 211 decoding AV information from a stream output from tuner 201 and outputting the results to video/audio external output unit 220; a program information extracting unit 212 extracting EPG information included in the SI/PSI information of the stream output from tuner 201, and recording it in program information storage unit 221; a recommended program extracting unit 213, reading program information stored in program information storage unit 221 and information of past recorded programs stored in recommended program/recording schedule storage unit 222, for extracting a recommended program based on these pieces of information and storing the same; a recording schedule generating unit 214 for generating recording schedule based on automatic recording setting and recommended program stored in recommended program extracting unit 213; and a reserved program/recommended program searching unit 215, responsive to IP communication unit 202 obtaining EPG information of a specific program from, for example, the first program viewing apparatus 31, for executing a program as will be described later, to search for recording reserved programs, recommended programs and recorded programs of the first recording apparatus 32 using the EPG information as a key, and transmitting the search result to the program viewing apparatus as the source of transmission of the EPG information.

The recording reserved program generally includes a program of which recording is reserved by the user, by designating a specific program from a program list or the like, and an auto-reserved program of which recording is automatically reserved based on settings of genre, keyword or the like. Here, for simplicity of description, it is assumed that only the auto-reservation is made.

Processing unit 210 further includes: a recording unit 216 for selecting a tuner and storing a stream input to processing unit 210 in content storage unit 223, in accordance with the recording schedule stored in recommended program/recording schedule storage unit 222, instruction from user operation unit 203 and a recording instruction from IP communication unit 202; and a content management unit 217 for managing content stored in content storage unit 223. Video/audio decoding unit 211, program information extracting unit 212, recommended program extracting unit 213, recording schedule generating unit 214, reserved program/recommended program searching unit 215, recording unit 216 and content management unit 217 can communicate with each other.

Video/audio external output unit 220 is connected to processing unit 210, and outputs signals provided from video/audio decoding unit 211 to an external apparatus, such as the first program viewing apparatus 31 shown in FIG. 1, connected to the first recording apparatus 32.

Program information storage unit 221 is connected to processing unit 210, and stores EPG information output from program information extracting unit 212.

Recommended program/recording schedule storage unit 222 is connected to processing unit 210, for storing pieces of information related to the recommended programs, auto-reserved programs and recorded programs generated by recommended program extracting unit 213 and recording schedule generating unit 214 as well as the recording schedule. The pieces of information related to the recommended program and recorded program are provided in the similar manner as program information 160 shown in FIG. 3. In the following, information related to a recorded program will be referred to as recording history.

Content storage unit 223 is connected to recording unit 216 and stores content recorded by recording unit 216.

If an instruction of reproduction, for example, is issued from user operation unit 203, video/audio decoding unit 211 reads the corresponding stored information stored in content storage unit 223, and executes the process.

In the present embodiment, program information storage unit 221, recommended program/recording schedule storage unit 222 and content storage unit 223 are substantially an HDD.

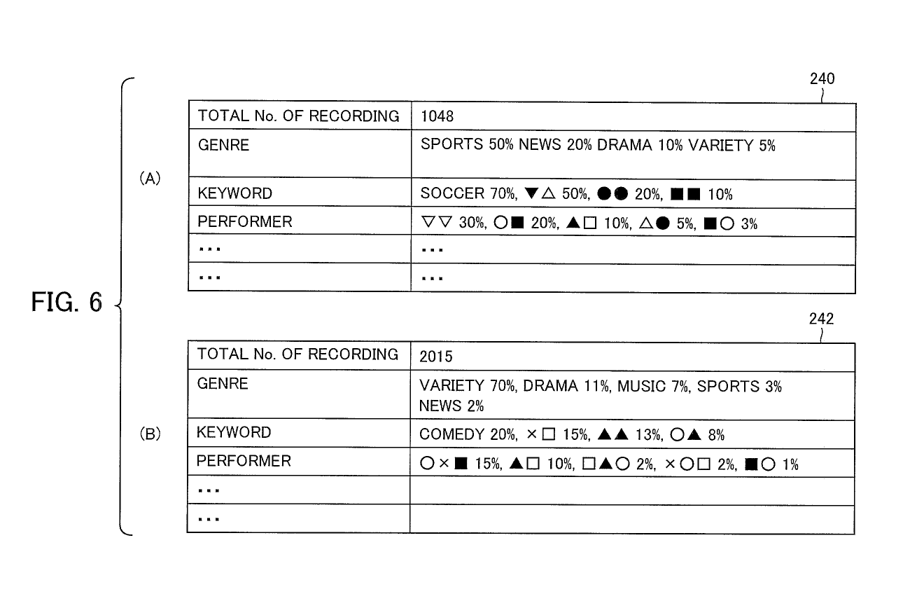

FIG. 6 show examples of preference information related to recording of the first and second recording apparatuses 32 and 34, formed by recommended program extracting unit 213 based on the past recording history stored in recommended program/recording schedule storage unit 222 in the first recording apparatus 32 shown in FIG. 5.

Referring to FIG. 6, as preference information 240 related to the first recording apparatus 32 and preference information 242 related to the second recording apparatus 34, words corresponding to attributes such as genre, keyword and performer are extracted from past recording history, and for each attribute, top five most frequently appeared words are displayed together with the rate of appearance. The rate of appearance is, if the word of interest relates to the genre, the rate of appearance of the word, with total sum of all words corresponding to the genre appeared being 100%.

It is noted that the recording history stored in recommended program/recording schedule storage unit 222 does not necessarily include words corresponding to all attributes. Therefore, for the preference information, it is not always possible to extract 5 or more words corresponding to each attribute, as in the examples of preference information 240 and 242.

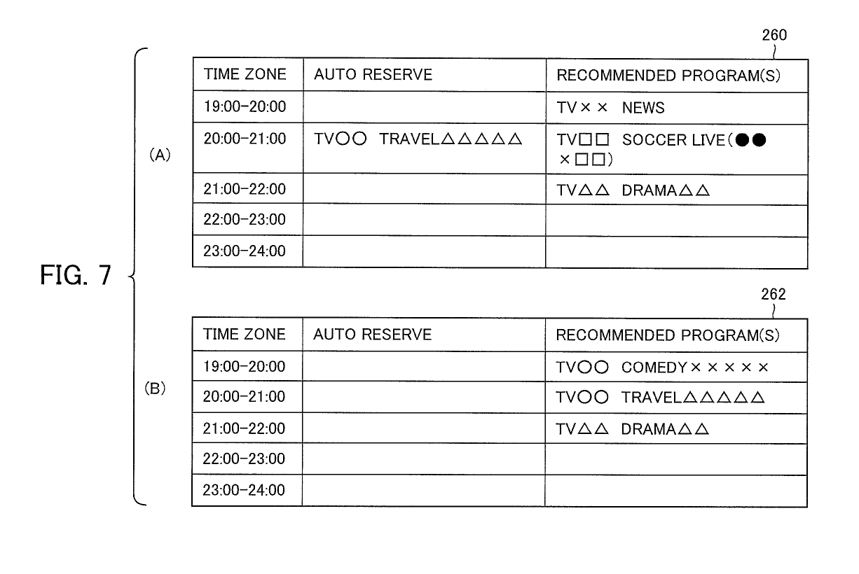

FIG. 7 shows exemplary lists of auto-reserved programs and recommended programs generated by recording schedule generating unit 214 based on the auto-recording instruction by the user from user operation unit 203 and the preference information formed by recommended program extracting unit 213, for example, in the first recording apparatus 32 shown in FIG. 5.

Referring to FIG. 7(A), list 260 includes, for the first recording apparatus 32, pieces of information related to the name of broadcasting station, program title and date and time of broadcast for auto-reserved programs and the recommended programs extracted by recommended program extracting unit 213. Here, it is assumed that, as the recommended programs, programs of which genre has the rate of appearance of 10% or higher are listed, in accordance with preference information 240 shown in FIG. 6. If an extracted program has already been registered as an auto-reserved program, recording schedule generating unit 214 excludes the program from the recommended programs. A recommended program is not recorded unless a user's instruction to record the program is received.

Referring to FIG. 7(B), a list 262 includes information similar to that of list 260, related to the auto-reserved programs and recommended programs in the second recording apparatus 34.

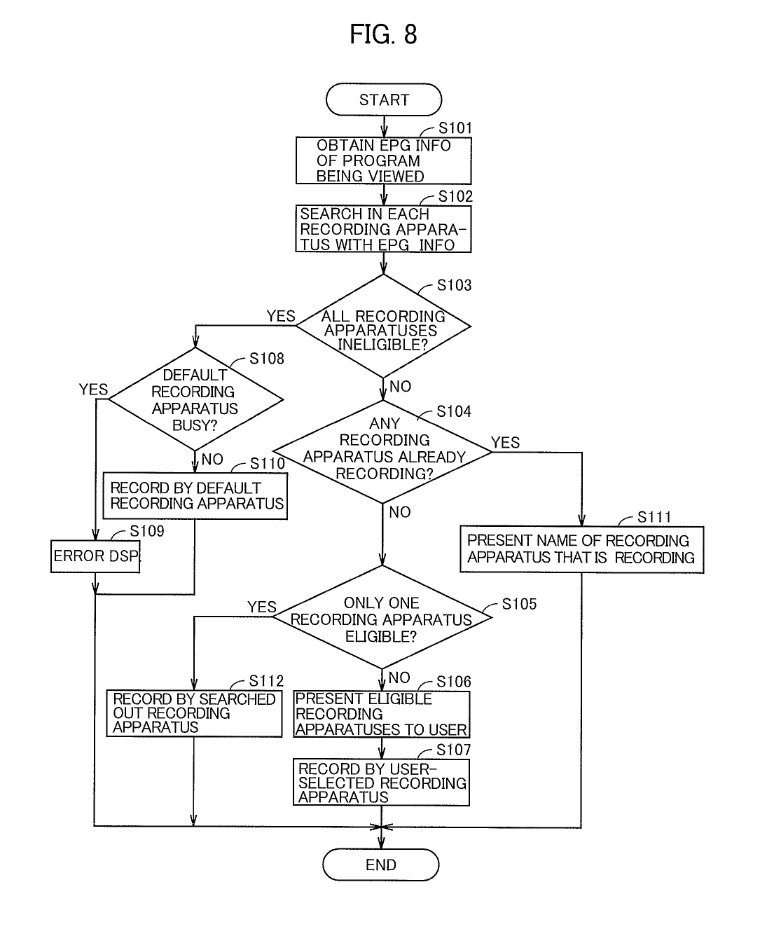

FIG. 8 is a flowchart of a program, activated in response to a user's instruction to record a program that is viewed on the first program viewing apparatus 31, for selecting an optimal recording apparatus from the recording apparatuses connected to home NW 30 and executing recording, executed by home NW recording apparatus selection control unit 115 shown in FIG. 2.

Referring to FIG. 8, the program for main control of recording apparatus selection includes a step (hereinafter denoted as “S”) 101 of obtaining EPG information of the program from channel selection information obtaining unit 113 shown in FIG. 2. The EPG information here refers to pieces of information related to the broadcast station, program title, date and time of broadcast, genre, program summary and performers, such as viewing program information 160 shown in FIG. 3. In the following, for convenience of description, the set of pieces of information will be referred to as “EPG1”.

The program further includes S102 of obtaining an address of each of the recording apparatuses on home NW 30 recorded on home NW setting storage unit 123, sending a search request using EPG1 as a search key to each recording apparatus on home NW 30 through IP communication unit 102, and in response, receiving the result of search transmitted from each of the recording apparatuses on home NW 30. At S102, each recording apparatus transmits the result of search indicating it is recording the program of interest, it is busy as it is recording another program, or it is eligible for recording the program, to the first program viewing apparatus 31. Details of the response from recording apparatuses at S102 will be described later.

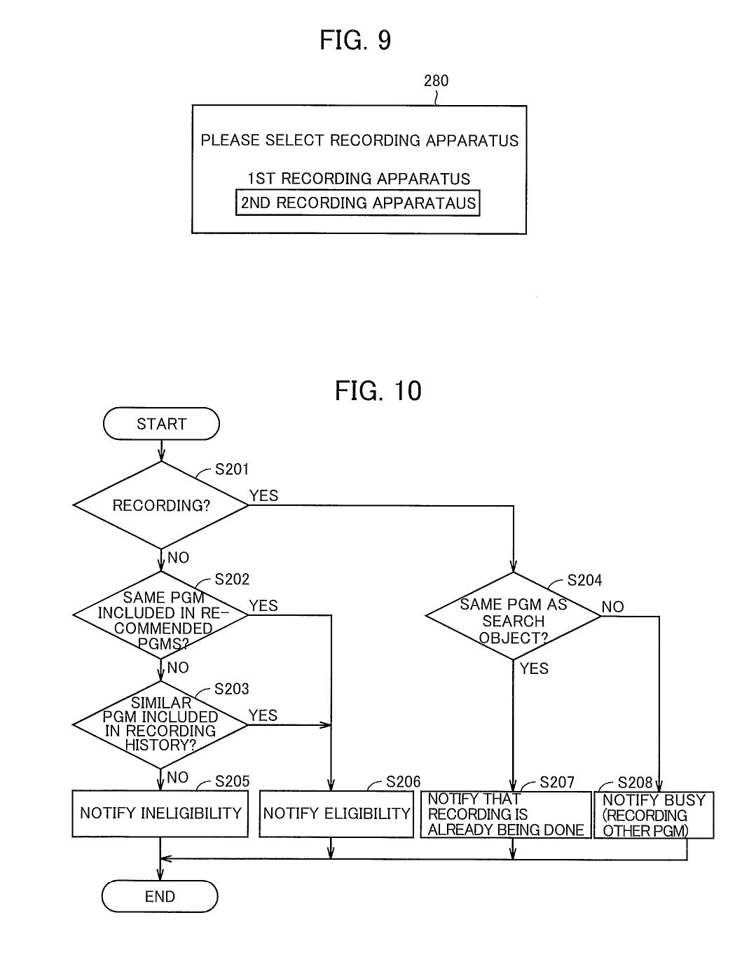

The present program further includes: S103, executed following S102, of determining whether or not all recording apparatuses are ineligible for recording the program, and branching the control flow depending on the result of determination; S104, executed if it is determined at S103 that not all the recording apparatuses are ineligible for recording, of determining whether any recording apparatus is already recording the program, and branching the control flow depending on the result of determination; S111, executed if it is determined at S104 that a recording apparatus is already recording the program, of displaying the name of the recording apparatus that is recording the program on display unit 119 shown in FIG. 2 and ending the process; S105, executed if it is determined at S104 that no recording apparatus is recording the program, of determining whether there is only one eligible recording apparatus or not, and branching the control flow depending on the result of determination; S106, executed if it is determined at S105 that more than one recording apparatuses are eligible for recording, of displaying names of eligible recording apparatuses on display unit 119 shown in FIG. 2, as shown by an image 280 of FIG. 9, to receive user's selection; and S107, executed following S106, of transmitting an instruction to record the program to the recording apparatus selected at S106 through IP communication unit 102, and ending the process.

The program further includes: S112, executed if it is determined at S105 that only one recording apparatus is eligible, of transmitting the instruction to record the program to the eligible recording apparatus and ending the process; S108, executed if it is determined at S103 that all recording apparatuses are ineligible, of determining whether or not a default recording apparatus is busy at the broadcast time of the program, and branching the control flow depending on the result of determination; S109, executed if it is determined at S108 that the default recording apparatus is busy, of presenting an error display on display unit 119 shown in FIG. 2, and ending the program process; and S110, executed if it is determined at S108 that the default recording apparatus is not busy, of instructing the default recording apparatus to record the program, and thereafter ending the process.

FIG. 9 shows an example of a display image including the name of eligible recording apparatus, displayed on display unit 119 of first program viewing apparatus 31 shown in FIG. 2. By the display image, the first program viewing apparatus 31 receives selection of the recording apparatus by which recording is to be executed, from the user. Referring to FIG. 9, display image 280 includes displays of names of the first and second recording apparatuses 32 and 34. In the example of FIG. 9, the second recording apparatus 34 is selected by the cursor. Here, assuming that the operator of the last operation is the same as the operator of the present operation, the cursor is focused on the name of the recording apparatus used for the last operation.

FIG. 10 is a flowchart of a program activated in response to reception by a recording apparatus on home NW 30 of EPG information of a certain program from a program viewing apparatus, and executed by reserved program/recommended program searching unit 215, of notifying the program viewing apparatus the result of determination as to whether the recording apparatus is eligible or not.

Referring to FIG. 10, the program includes: S201 of determining whether or not the recording apparatus is recording at present, and branching the control flow depending on the result of determination; S202, executed if it is determined at S201 that the recording apparatus is not recording at present, of determining whether or not the program is included in the list of recommended programs stored in recommended program/recording schedule storage unit 222 shown in FIG. 5, and branching the control flow depending on the result of determination; and S203, executed if it is determined at S202 that the program is not included in the list of recommended programs, of determining whether or not a program similar to the program of interest is included in the recording history stored in the recommended program/recording schedule storage unit 222, and branching the control flow depending on the result of determination. Details of the method of determination at S203 will be described later.

The program further includes: S205, executed if it is determined at S203 that any program similar to the program of interest is not included in the recording history, of notifying the program viewing apparatus through IP communication unit 202 that the recording apparatus is ineligible; and S206, executed in response to the determination of YES at S202 or S203, of notifying the program viewing apparatus that the recording apparatus is eligible. After S205 and S206, the process ends.

The present program further includes: S204, executed if it is determined at S201 that recording is being done at present, of determining whether or not the object of recording is the same as the object of search, and branching the control flow depending on the result of determination; S207, executed if it is determined at S204 that the program being recorded is the same as the object of search, of notifying the program viewing apparatus that the program has already been set for recording and is being recorded; and S208, executed if it is determined at S204 that the program being recorded is not the same as the object of search, of notifying the program viewing apparatus that the recording apparatus is recording another program and is busy. After S207 and S208, the process ends.

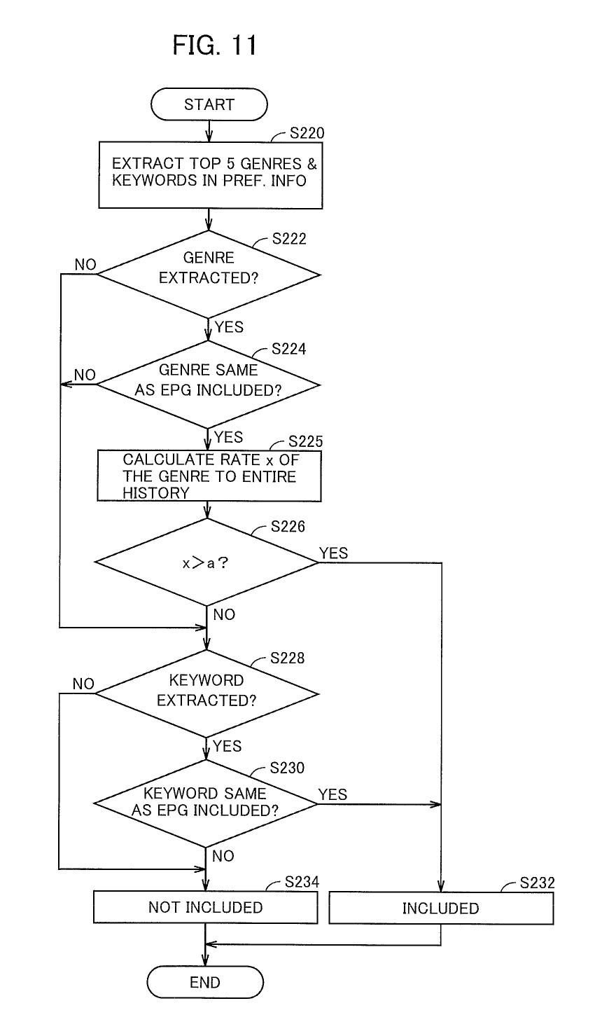

FIG. 11 shows a flowchart of a program for making determination of S203, executed by reserved program/recommended program searching unit 215 in response to the determination of NO at S202 shown in FIG. 10.

Referring to FIG. 11, the present program includes: S220, of extracting, based on the preference information of the recording apparatus formed and stored by recommended program extracting unit 213, words having the top five rates of appearance from among words related to the genre and keyword; S222, executed following S220, of determining whether or not a word or words related to the genre have been extracted, and branching the control flow depending on the result of determination; and S224, executed if it is determined at S222 that a word or words related to the genre have been extracted, of determining whether or not the word or words related to the genre extracted at S220 include one of the same genre as EPG1, and branching the control flow depending on the result of determination.

The program further includes: S225, executed if it is determined at S224 that the same genre as EPG1 is included, of extracting the ratio x % of the word related to the genre with respect to the entire history; and S226, executed after S225, of determining whether or not the ratio x % exceeds a predetermined threshold value a, and branching the control flow depending on the result of determination. Here, a=5.

The program further includes: S228, executed if the determination is NO at S222, S224 and S226, of determining whether or not a word or words related to keyword have been extracted at S220, and branching the control flow depending on the result of determination; and S230, executed if it is determined at S228 that a word or words related to keyword have been extracted, of determining whether the extracted words related to the keyword include the same one as EPG1, and branching the control flow depending on the result of determination.

The program further includes: S232, executed in response to determination of YES at S226 and S230, of determining that a program similar to EPG1 is included in the recording history of the recording apparatus; and S234, executed in response to the determination of NO at S228 and S230, of determining that any program similar to EPG1 is not included in the recording history of the recording apparatus. After S232 and S234, the process ends.

—Operation—

The program recording system 10 having the structure above operates in the following manner. In the following, for convenience of description, it is assumed that main powers of all components related to program recording system 10 are always on.

Referring to FIGS. 1 and 2, assume that a user issues an instruction to record the program he/she is viewing, from remote controller 40 to first program viewing apparatus 31 in the living room. Receiving the instruction, user operation unit 103 of first program viewing apparatus 31 notifies home NW recording apparatus selection control unit 115 of the recording instruction. In response to the recording instruction, home NW recording apparatus selection control unit 115 activates the program having the control structure shown in FIG. 8.

At S101 and S102 shown in FIG. 8, home NW recording apparatus selection control unit 115 obtains program information EPG1 of the program that is being viewed, from channel selection information obtaining unit 113. Home NW recording apparatus selection control unit 115 obtains information related to the apparatuses connected to home NW 30, from home NW setting storage unit 123. Here, assume that the obtained information was home NW apparatus information 180 shown in FIG. 4. Home NW recording apparatus selection control unit 115 selects, based on the available function information and state information of each apparatus included in home NW apparatus information 180, a recording apparatus that can record at that time, from among the connected apparatuses. Home NW recording apparatus selection control unit 115 obtains the IP addresses of selected first and second recording apparatuses 32 and 34, and transmits a search request to the IP addresses, through IP communication unit 102.

Referring to FIG. 5, assume that IP communication unit 202 of each of the first and second recording apparatuses 32 and 34 received the search request from the first program viewing apparatus 31. In response, reserved program/recommended program searching unit 215 executes the program having the control structure shown in FIG. 10. The recording apparatus makes a determination through the process of this program, and sends any of the following four notices based on the recording state and recording history of the recording apparatus, to the first program viewing apparatus 31 through IP communication unit 202.

<Notice from Recording Apparatus to Program Viewing Apparatus>

1. Notice if Recording of the Program has Already been Set (S207)

This notice is issued if recording is being done at present (YES at S201) and the object of recording is the same program as that indicated by EPG1 (YES at S204).

2. Busy Notice (S208)

This notice is issued if recording is being done at present (YES at S201) and the object of recording is a program different from the one indicated by EPG1 (NO at S204).

3. Notice if the Recording Apparatus is Eligible for Recording the Program (S206)

This notice is issued if recording is not being done at present (NO at S201), and the same program as indicated by EPG1 is included in the auto-reserved information and recommended program information stored in recommended program/recording schedule storage unit 222 (YES at S202), or if a similar program is included in the recording history stored in recommended program/recording schedule storage unit 222 (YES at S203).

4. Notice if the Recording Apparatus is Ineligible for Recording the Program (S205)

This notice is issued if recording is not set at the time (NO at S201), the same program as indicated by EPG1 is not included in the auto-reserved information and recommended program information stored in recommended program/recording schedule storage unit 222 (NO at S202), and no similar program is included in the recording history stored in recommended program/recording schedule storage unit 222 (NO at S203).

Here, determination as to whether any program similar to the program is included in the recording history is made by the program having the control structure shown in FIG. 11, which is executed in response to the determination of NO at S202. At S220, reserved program/recommended program searching unit 215 extracts words related to the genre and the keyword having top five rates of appearance from the preference information of the recording apparatus stored in recommended program/recording schedule storage unit 222 and calculated by recommended program extracting unit 213. If the extracted words related to the genre include one that is the same as EPG1, and the rate of appearance of the word exceeds 5% (YES at S222, S224 and S226), or if the extracted words corresponding to the keyword include one that is the same as EPG1 though the conditions above are not satisfied (YES at S228 and S230), reserved program/recommended program searching unit 215 determines that the recording apparatus is eligible and otherwise, determines it is ineligible. Reserved program/recommended program searching unit 215 notifies the first program viewing apparatus 31 of the result of determination.

Receiving the notice from the recording apparatus on the home NW, home NW recording apparatus selection control unit 115 of the first program viewing apparatus 31 executes the following process. If there is a recording apparatus that is already recording the program (NO at S103, YES at S104), it displays the name of the recording apparatus on display unit 119. If the eligible recording apparatus is only one (YES at S105), it displays the name of the recording apparatus on display unit 119, and instructs the recording apparatus to record the program. If there are a plurality of eligible recording apparatuses (NO at S105), home NW recording apparatus selection control unit 115 displays an image including the names of the eligible recording apparatuses such as shown in FIG. 9, on display unit 119 (S106). If the user selects a recording apparatus to execute recording on the displayed image by an operation of the remote controller, home NW recording apparatus selection control unit 115 instructs the recording apparatus to record the program (S107). If all recording apparatuses are ineligible (YES at S103), home NW recording apparatus selection control unit 115 confirms the recording state of a default recording apparatus of the first program viewing apparatus 31. If the recording apparatus is busy, home NW recording apparatus selection control unit 115 displays an error display that recording is impossible on display unit 119. Otherwise, it issues a recording instruction to the recording apparatus.

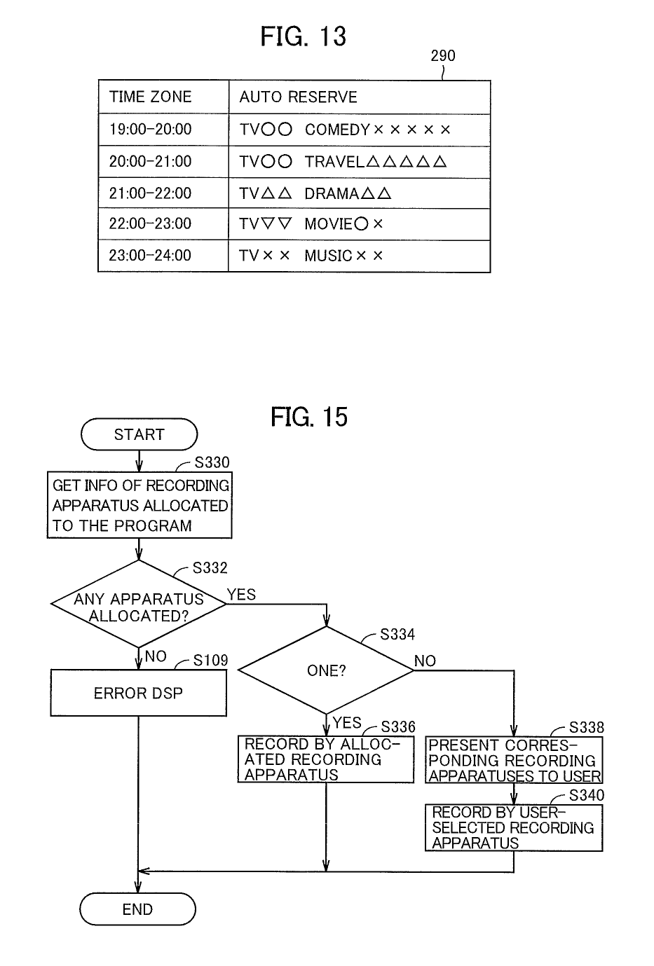

FIG. 13 is a time table 290 of the programs viewable by the first program viewing apparatus 31, for specific description of the operation of program recording system 10 shown in FIG. 1. It is assumed that from 19:00 to 24:00, the user views programs shown in time table 290 using the first program viewing apparatus 31, and instructs recording of each program. Referring to FIGS. 1, 2, 5 and 13, operation of system 10 for recording each program will be described in the following.

<Example of Specific Operation with Respect to Time Table 290>

1. From 19:00 (Channel “TV◯◯” Broadcasting “Comedy Show xxxxx”)

Here, assume that the program information corresponds to program information 170 shown in FIG. 3. Home NW recording apparatus selection control unit 115 of the first program viewing apparatus 31 transmits program information 170 to the first and second recording apparatuses 32 and 34. Here, it is assumed that the recording schedules stored in recommended program/recording schedule storage unit 222 of the first and second recording apparatuses 32 and 34 are recording schedules 260 and 262 shown in FIG. 7, respectively, and that recording of a recommended program is not instructed.

The first and second recording apparatuses 32 and 34 are not recording, and in recording schedule 262 of the second recording apparatus 34 only, a program being viewed is included in the recommended program. Therefore, the second recording apparatus notifies the first program viewing apparatus 31 that it is eligible.

In the first recording apparatus 32, the recording history is compared with the information of the program that is being viewed. Reserved program/recommended program searching unit 215 reads preference information 240 shown in FIG. 6 from recommended program extracting unit 213, and compares it with program information 170. According to program information 170, the genre of EPG1 is “variety” and in preference information 240, the rate of appearance of “variety” does not exceed the threshold value a. Therefore, keywords are compared. Here, if the recording history does not include any keyword that matches one in EPG1, it is determined that the recording history does not include any program similar to EPG1. The first recording apparatus 32 notifies the first program viewing apparatus 31 that it is ineligible.

The eligible recording apparatus is only the second recording apparatus 34 and, therefore, the first program viewing apparatus 31 instructs the second recording apparatus 34 to record the program.

2. From 20:00 (Channel “TV◯◯” Broadcasting “Travel ΔΔΔΔΔ”)

Reserved program/recommended program searching unit 215 of the first recording apparatus 32 notifies the first program viewing apparatus 31 that the program is already being recorded, as the program is auto-reserved in recording schedule 260.

On the other hand, reserved program/recommended program searching unit 215 of the second recording apparatus 34 notifies the first program viewing apparatus 31 that it is eligible, since the program is set as a recommended program in recording schedule 262.

Receiving the notices from the first and second recording apparatuses 32 and 34, home NW recording apparatus selection control unit 115 of the first program viewing apparatus 31 displays the name of the first recording apparatus 32, since the first recording apparatus 32 is recording the program.

3. From 21:00 (Channel “TVΔΔ” Broadcasting “DramaΔΔ”)

The program is registered as a recommended program both in recording schedule 260 of the first recording apparatus 32 and recording schedule 262 of the second recording apparatus 34. Therefore, the first and second recording apparatuses 32 and 34 notify the first program viewing apparatus 31 that they are eligible. Since there are a plurality of eligible recording apparatuses, home NW recording apparatus selection control unit 115 of the first program viewing apparatus 31 displays the image 280 shown in FIG. 9 on display unit 119. If the user selects the second recording apparatus 34 as in the exemplary image 280, the first program viewing apparatus 31 instructs the second recording apparatus 34 to record the program.

4. From 22:00 (Channel “T∇∇” Broadcasting “Movie ◯x”)

The program is not registered as an auto-reserved program or a recommended program either in recording schedule 260 of the first recording apparatus 32 or recording schedule 262 of the second recording apparatus 34. Here, assume that a program similar to this program does not exist in the recording history of each of the first and second recording apparatuses 32 and 34. The first and second recording apparatuses 32 and 34 notify the first program viewing apparatus 31 that they are ineligible. Now, assume that the default recording apparatus for the first program viewing apparatus 31 is the first recording apparatus 32. From recording schedule 260, it is known that the first recording apparatus 32 is not busy. Therefore, the first program viewing apparatus 31 instructs the first recording apparatus 32 to record the program.

5. From 23:00 (Channel “TVxx” Broadcasting “Music xx”)

The program is not registered as an auto-reserved program or a recommended program either in recording schedule 260 of the first recording apparatus 32 or recording schedule 262 of the second recording apparatus 34. Here, assuming that the genre of the program is “music”, according to preference information 240 and 242, a similar program exists in the recording history of only the second recording apparatus 34 (“genre music 7%” in preference information 242). The first recording apparatus 32 notifies the first program viewing apparatus 31 that it is ineligible.

Reserved program/recommended program searching unit 215 of the second recording apparatus 34 compares EPG1 with the recording history. From preference information 242, the word “music” is extracted as a word that corresponds to the genre, and the rate of appearance of “music” exceeds 5%. Therefore, the second recording apparatus 34 notifies the first program viewing apparatus 31 that is eligible. Then, the first program viewing apparatus 31 instructs the second recording apparatus 34 to record the program.

In the example above, for the recording of variety programs from 19:00 and from 20:00 and recording of music program from 23:00, the second recording apparatus 34 owned by the user is selected, in view of the recording history and the preference information. This is because the inclination of recording instruction by the user is similar to the inclination of recording history of the second recording apparatus 34.

As described above, in the program recording system, in the home NW, a recording apparatus for executing recording of a program is selected in view of recording history of each recording apparatus, from among the plurality of recording apparatuses on the NW. Therefore, it is possible to select the recording apparatus owned by an individual without necessitating troublesome operations and works of individual authentication.

If the recording apparatuses owned by individuals have much different inclinations in the recording histories, the possibility of selecting the recording apparatus owned by the individual becomes higher, as in the case where the first recording apparatus 32 records sports programs only and the second recording apparatus 34 records variety programs only.

### MODIFICATION OF THE PRESENT EMBODIMENT

Home NW 30 may be connected to a global network through a gate way apparatus. Various apparatuses included in program recording system 10 may access various servers connected to the global network.

In the embodiment described above, home NW 30 is a wired LAN. The present invention, however, is not limited to such an embodiment. Home NW 30 may be a wireless LAN (IEEE802. 11a/b/g).

The broadcast signals received by antenna 100 may be of any data format. By way of example, antenna 100 can receive broadcast signal transmitted as RF (Radio Frequency) signals. Alternatively, antenna 100 can receive broadcast signals transmitted as radio signals, or transmitted from CATV (Cable television) facilities. Further, antenna 100 may function as a network interface capable of receiving streaming data of IP multicast, through an IP network.

In the embodiment described above, tuner 101 receives broadcast signals using antenna 100. The present invention, however, is not limited to such an embodiment. Tuner 101 may directly access a server storing the program list information on a global network, such as the Internet, and it may obtain the program list information from the server.

The search request describe above includes data that can serve as keywords related to the program, such as the program title, genre and performer. In addition, it may further include an identifier consisting of an alpha-numeric combination for identifying each program. If the search request includes an identifier, recording apparatuses 32 and 34 may obtain a keyword and the like related to the program, by searching in program information storage unit 221 with the identifier as a key. Further, SI/PSI information may be obtained from tuner 201.

In the embodiment described above, the program viewing apparatus may be a portable terminal such as a portable telephone. In that cast, channel selection information obtaining unit 113 may receive the information related to a specific program by e-mail. The portable terminal may include a camera for reading a bar-code or a QR code (registered trademark), and the program information may be extracted from the bar-code or the QR code.

If an identifier for identifying program information (for example, URL, G code, and program start time) is available, the identifier may be transmitted included in the search request, from IP communication unit 102 to the recording apparatus. In the process of S201 and thereafter, what is required of the recording apparatus is to search for the corresponding program from the program information stored in program information storage unit 221 in the recording apparatus. Therefore, it is unnecessary to transmit large amount of data, and hence, it is efficient.

On the other hand, it is also effective to send the program information itself, rather than the identifier.

The portable terminal may have a function allowing the user to freely modify the program information. Assume, for example, that program information transmitted by e-mail from a certain service included “Professional Baseball News”. Further assume that on the day, the user's favorite team “Japan Triangles” won the championship and hence, it was expected that related topics would surely be introduced in the program. Then, the user modified part of the program information (such as the title), and transmitted the information in search request, through IP communication unit 102. Then, it follows that the recording apparatus determines whether or not it is eligible, based on the modified title. As a result, it becomes more likely that the recording apparatus owned by the user storing programs related to “Japan Triangles” is used for recording. Thus, recording is done by a more appropriate recording apparatus.

It is not necessary to make modification of the program information on the portable terminal. If a service modifying the title (since modification of the title may possible cause a problem related to copyright law, an alternative may be included) or adding a keyword is available, the transmitted program information may be directly included in the search request and transmitted, to attain similar effects.

Further, after the recording apparatus is selected, the information transmitted from the portable terminal may be transmitted again when requesting recording, so that the recorded content may be identified by the transmitted title.

Though user operation unit 103 has been described to allow the user to directly operate the program viewing apparatus, the present invention is not limited to such an embodiment. User operation unit 103 may communicate with a device for user operation.

By way of example, the portable terminal (portable telephone, personal computer, portable game machine or the like) may transmit information to be displayed on a UI (User Interface) terminal through user operation unit 103, or it may receive content of user operation on the UI terminal from the UI terminal.

### Second Embodiment

In the second embodiment of the present invention, which is similar to the first embodiment, recording apparatuses for executing recording are allocated to all programs included in the EPG information obtained by the program viewing apparatus at prescribed time points. After processing, each allocated recording apparatus is displayed in the corresponding program information in the EPG information displayed in accordance with an instruction by the viewer. Recording of the program is executed in accordance with an instruction by the user.

According to the present embodiment, before receiving a recording instruction from the user, selection of the recording apparatus to be used for the recording has already been finished. Therefore, when the recording instruction is received from the user, the recording instruction can immediately be transmitted to the recording apparatus. As compared with the first embodiment in which the process for determining the recording apparatus starts in response to the recording instruction from the user, time lag between the user instruction and execution of recording can be reduced.

In the following embodiment, the configuration, operation and effects are the same as those of the first embodiment, except for the program for selecting the recording apparatus suitable for recording the program of interest having the control structure shown in FIG. 8. Therefore, description of the same portions will not be repeated.

—Configuration—

The configuration of program viewing apparatus included in the program recording system is similar to that of the first program viewing apparatus 31 shown in FIG. 2. It is noted, however, that the program information storage unit of the present embodiment is different from program information storage unit 121 shown in FIG. 2 in that an identifier of a recording apparatus output from home NW recording apparatus selection control unit 115 is stored in association with the program information, in the program as will be described later. Storage of the identifier of a recording apparatus in association with the program information is described as “allocation of recording apparatus to a program” in the following.

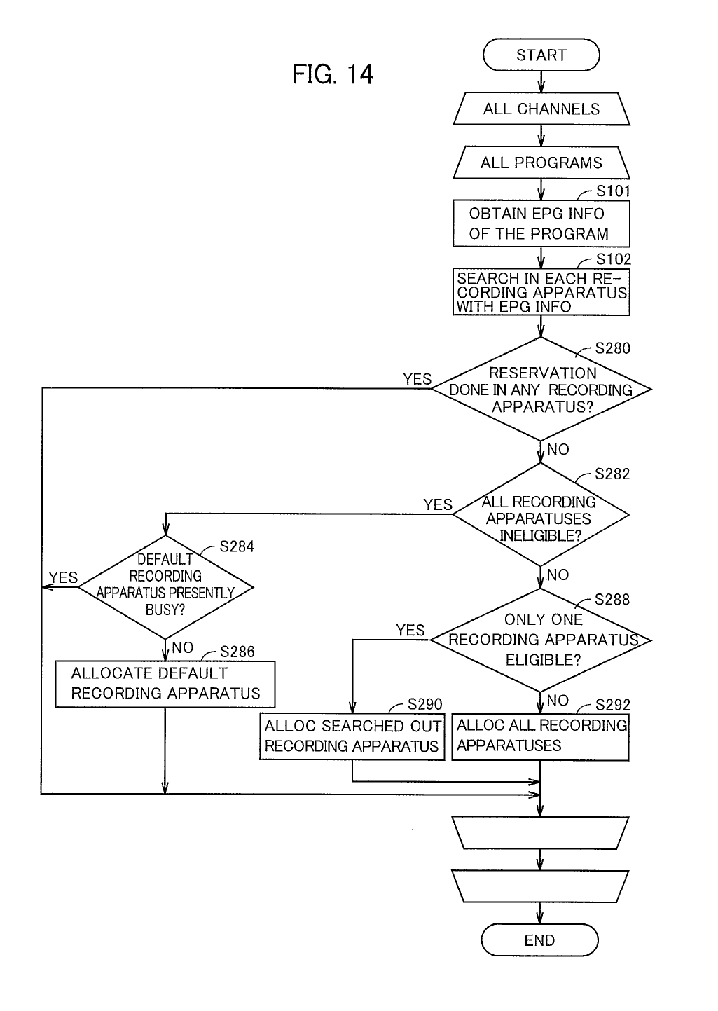

FIG. 14 is a flowchart activated every time the program viewing apparatus obtained the EPG information, for allocating a recording apparatus to execute recording of the program, executed by home NW recording apparatus selection control unit 151, in place of the program having the control structure shown in FIG. 8, in the program recording system in accordance with the present embodiment.

Referring to FIG. 14, the program includes: S101 and S102, which are the same as those shown in FIG. 8; S280, executed after S102, of determining whether or not there is a recording apparatus in which recording of the program is reserved, and branching the control flow depending on the result of determination; S282, executed if it is determined at S280 that there is no recording apparatus in which recording of the program is reserved, of determining whether or not all recording apparatuses are ineligible, and branching the control flow depending on the result of determination; S284, executed if it is determined at S282 that all recording apparatuses are ineligible, of determining whether or not a default recording apparatus is busy at the corresponding time, and branching the control flow depending on the result of determination; and S286, executed if it is determined that the default recording apparatus is not busy, of allocating the default recording apparatus to the program. After S286, if the determination at S280 or S284 is YES, the process proceeds to the next program.

The program further includes: S288, executed if it is determined at S282 that not all recording apparatuses are ineligible, of determining whether or not there is only one eligible recording apparatus, and branching the control flow depending on the result of determination; S290, executed if it is determined at S288 that only one recording apparatus is eligible, of allocating the eligible recording apparatus to the program; and S292, executed if it is determined at S288 that more than one recording apparatuses are eligible, of allocating the plurality of recording apparatuses to the program. After S290 and S292, the process proceeds to the next program.

In the present program, the process steps are carried out for one program, and when the process steps end, the same process steps are carried out on another program broadcast on the same channel, included in the obtained EPG information. By repeating the process steps, all programs of one channel included in the EPG information are processed.

Further, when the process on one channel ends, in the present program, the above-described process steps are carried out on another channel included in the obtained EPG information. By repeating the process steps, all programs of all channels included in the EPG information are processed.

FIG. 15 shows a flowchart of a program, activated when the user instructs recording of a specific program included in the EPG information obtained by the program viewing apparatus, for issuing a recording instruction to the allocated recording apparatus, executed by home NW recording apparatus selection control unit 115 shown in FIG. 2.

Referring to FIG. 15, the program includes: S330 of obtaining information of the recording apparatus allocated to the program; S332, executed following S330, of determining whether or not a recording apparatus has been allocated to the program, and branching the control flow depending on the result of determination; S109, executed if it is determined at S332 that no recording apparatus has been allocated to the program, of displaying an error display on display unit 119 of the program viewing apparatus and ending the process; S334, executed if it is determined at S332 that a recording apparatus or recording apparatuses are allocated to the program, of determining whether only one recording apparatus is allocated to the program, and branching the control flow depending on the result of determination; S336, executed if it is determined at S334 that one recording apparatus is allocated to the program, of instructing the corresponding recording apparatus to record the program and ending the process; S338, executed if it is determined at S334 that more than one recording apparatuses have been allocated to the program, of displaying names of corresponding recording apparatuses on display unit 119 of the program viewing apparatus; and S340, executed following S338, of instructing the recording apparatus selected by the user to record the program. After S109, S336 and S340, the process ends.

—Operation—

The program recording system in accordance with the present embodiment operates in the following manner. For convenience of description, it is assumed that main powers of all components related to the program recording system are on.

Referring to FIG. 2, the program viewing apparatus obtains streams including EPG information through antenna 100 and tuner 101, at prescribed time points. The prescribed time points include, for example, 6:00, 7:00, 9:00, 11:00, 13:00, 15:00, 19:00, 21:00 and 23:00 of the day.

From the streams obtained at these prescribed time points, program information extracting unit 112 extracts the EPG information, and stores it in the program information storage unit.

Further, in response to the streams being obtained, home NW recording apparatus selection control unit 115 activates the program having the control structure shown in FIG. 14. At S101, home NW recording apparatus selection control unit 115 obtains the EPG information of a certain program broadcast on a certain channel, from the EPG information. The operation of home NW recording apparatus selection control unit 115 at S102 is the same as that in the first embodiment.

Receiving the EPG information, each recording apparatus on the home NW executes the program having the control structure shown in FIG. 10 as in the first embodiment, and notifies the program viewing apparatus of the result of processing (any of S205 to S208 of FIG. 10).

Receiving notices from each recording apparatus, the program viewing apparatus allocates the recording apparatus to the program in the following manner. If there is any recording apparatus in which recording of the program has been reserved (YES at S280), or if all recording apparatuses are ineligible and the default recording apparatus is busy at the time of broadcast of the program of interest (NO at S280, YES at S282 and S284), home NW recording apparatus selection control unit 115 does not perform any operation. If only one recording apparatus is eligible (YES at S288), or if all recording apparatuses are ineligible and the default recording apparatus is not busy at the time of broadcast of the program of interest (No at S284), the corresponding recording apparatus is allocated to the program (S290 or S286). If a plurality of recording apparatuses are eligible (NO at S288), the plurality of recording apparatuses are allocated to the program (S292).

Home NW recording apparatus selection control unit 115 performs the process described above on every program of all channels included in the obtained EPG information. Home NW recording apparatus selection control unit 115 stores the information of allocated recording apparatus together with the EPG information of the corresponding program, in the program information storage unit.

Assume that, thereafter, the user operates the program viewing apparatus before obtaining the next piece of EPG information, and has the EPG program list displayed on display unit 119. At this time, if any recording apparatus has been allocated to each program, it is displayed as part of the program information. As a manner of display, here, an icon indicating each recording apparatus is displayed with the program title, on the row of each program of the EPG program list. Further, when the user selects a program and the detailed information of the program is displayed, the name of the recording apparatus is displayed together.

Assume that a certain program is selected from the displayed EPG program list and recording is instructed. In response, home NW recording apparatus selection control unit 115 executes the program having the control structure shown in FIG. 15.

Home NW recording apparatus selection control unit 115 obtains the identifier of the recording apparatus allocated to the program from the program information storage unit, and identifies the recording apparatus (S330). If only one recording apparatus is allocated (YES at S332, YES at S334), home NW recording apparatus selection control unit 115 instructs the recording apparatus to record the program. If a plurality of recording apparatuses are allocated (NO at S334), home NW recording apparatus selection control unit 115 displays an image allowing the user to select one from the eligible recording apparatuses, similar to the image shown in FIG. 9, on display unit 119. If the user selects a recording apparatus, home NW recording apparatus selection control unit 115 instructs the recording apparatus to record the program (S340). If no recording apparatus is allocated (NO at S332), home NW recording apparatus selection control unit 115 displays that recording is impossible, on display unit 119. The recording instruction from the program viewing apparatus to the recording apparatus is a recording request if the program is being broadcast at that time point, and it is a recording reservation request if the program is to be broadcast in the future.

### Third Embodiment

The third embodiment of the present invention is similar to the first embodiment. In the present embodiment, however, if a program that is being viewed is viewed continuously for a prescribed time period or longer, the viewing apparatus searches for a recording apparatus eligible for recording the program, without any user instruction. If an eligible recording apparatus is found as a result of search, it is stored. The program is recorded if the user instructs recording.

According to the present embodiment, before receiving a recording instruction from the user, selection of the recording apparatus to be used for the recording has already been finished. As compared with the first embodiment, time lag between the user instruction and execution of recording can be reduced.

Here, the prescribed time period is set to one minute and 30 seconds, from the following reason.

Generally, when one views programs, the viewer tends to more frequently channel-zap CMs inserted before and after or in the middle of a program, than to zap the main program. The reason for this is that the main program is viewed as the viewer wants to, while the CMs during the broadcast of the main program are not related to the user's demand. Therefore, if the user continuously views for a time period longer than the average time of CM broadcasting, it can be assumed that the user views a main program, and if the continuous viewing time is shorter than the broadcast time of CM, it can be assumed that the user is channel-zapping.

According to Non-Patent Document 1, a total time of broadcast of time-CM (broadcast as sponsoring the main program) in a so-called prime time (any three-hours and a half continuous broadcast time between 6:00 to 11:30 in the evening) is determined. If the program to be viewed is 60-minutes program, the total time of time-CM for the 60-minutes program is determined to be 6 minutes. Typically, for a 60-minutes program, CMs are inserted at the beginning and at the end of the program, and at every 15 minutes. Assuming that CMs are inserted 5 times in total, calculating from the total time mentioned above, average duration of one CM broadcasting is about one minute and 20 seconds. Therefore, if the same channel is kept for more than one minute and 30 seconds after the selection of the channel, it is assumed that the viewer is viewing a main program.

—Configuration—

The configuration of the program viewing apparatus included in the program recording system is the same as that of the program viewing apparatus of the second embodiment.

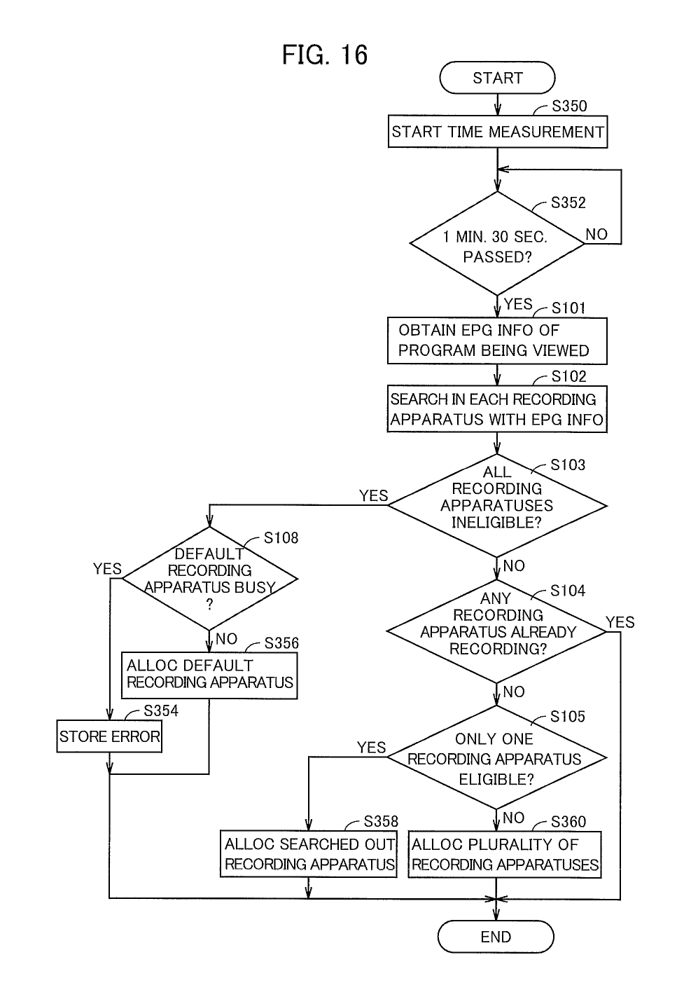

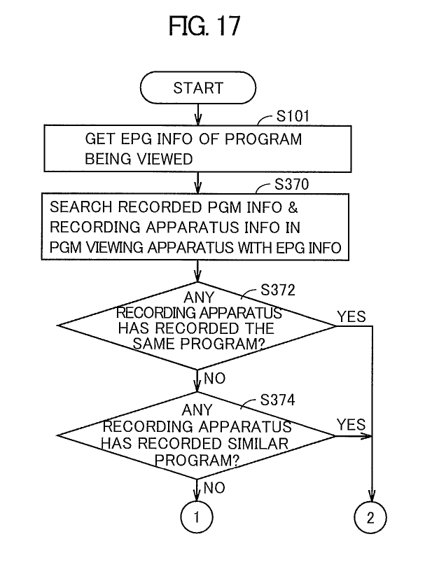

FIG. 16 is a flowchart of a program, activated in response to the start of viewing of a new program in the program recording system in accordance with the present embodiment, for allocating recording apparatus for executing recording of the program, executed by home NW recording apparatus selection control unit 115, in place of the program having the control structure shown in FIG. 8.

Referring to FIG. 16, the program for allocating a recording apparatus for executing recording of the program includes, similar to the program having the control structure shown in FIG. 8, S101, S102, S103, S104, S105 and S108. In place of S106, S107, S109, S110, S111 and S112, it includes, before S101, S350 of starting time measurement, and S352, executed after S350, of determining whether the measured time exceeded one minute and 30 seconds, and waits until the time passes one minute and 30 seconds.

The program further includes: S354, executed if it is determined at S108 that the default recording apparatus is busy, of storing error information in association with the program information in the program information storage unit; and S356, executed if it is determined at S108 that the default recording apparatus is not busy, of allocating the default recording apparatus for the program. After S354 and S356, the process ends.

The present program further includes: S358, executed if it is determined at S105 that only one recording apparatus is eligible, of allocating the searched out recording apparatus; and S360, executed if it is determined at S105 that more than one recording apparatuses are eligible, of allocating the plurality of recording apparatuses.

If a recording request is received from the user, the program viewing apparatus executes the program having the control structure shown in FIG. 15.

—Operation—

The program recording system in accordance with the present embodiment operates in the following manner. For convenience of description, it is assumed that main powers of all components related to the program recording system are on.

Assume that the user of the program viewing apparatus changes a channel and starts viewing a new program. Home NW recording apparatus selection control unit 115 activates the program having the control structure shown in FIG. 16. After one minute and 30 seconds from the start of viewing, if the program is continuously viewed (YES at S352), the program viewing apparatus transmits a search request including the EPG information of the program to recording apparatuses on the home NW (S102). In each recording apparatus, processes similar to those of the first embodiment are executed.

Receiving notices from the recording apparatuses, home NW recording apparatus selection control unit 115 of the program viewing apparatus performs the following process. If there is an apparatus that is already recording the program (YES at S104), no operation is done. If only one apparatus is eligible (YES at S105), home NW recording apparatus selection control unit 115 stores the identifier of the corresponding recording apparatus in association with the program information, in the program information storage unit. If there are a plurality of eligible recording apparatuses, home NW recording apparatus selection control unit 115 stores the eligible recording apparatuses as candidates (S360). If all recording apparatuses are ineligible and the default recording apparatus is not busy (NO at S108), home NW recording apparatus selection control unit 115 stores the identifier of the default recording apparatus (S358). If the default recording apparatus is busy (YES at S108), home NW recording apparatus selection control unit 115 stores error information indicating that recording is impossible, in association with the program information.

The operation when a recording instruction is received from the user is the same as that of the second embodiment. If recording is impossible, determination at S332 shown in FIG. 15 is NO.

### Fourth Embodiment

In the fourth embodiment of the present invention, the program viewing apparatus stores the program of which recording was executed and the recording apparatus used therefor as recording history. When a recording apparatus is to be selected for recording a program, the program viewing apparatus selects a recording apparatus based on the recording history.

According to the present embodiment, whether or not a recording apparatus is eligible is determined in the program viewing apparatus and, therefore, as compared with the first embodiment in which it is necessary to wait for a notice from each of the recording apparatuses on the NW, the time lag from user instruction to execution of recording can be reduced.

—Configuration—

The configuration of the program viewing apparatus included in the program viewing system is similar to that of the first program viewing apparatus 31 shown in FIG. 2. It is different, however, from the first program viewing apparatus 31 in that it additionally includes, in the storage area, an area connected to processing unit 110, for storing recording program information, which will be described later, and an identifier of the recording apparatus that recorded the program (hereinafter referred to as “recording apparatus information”) in association with each other.

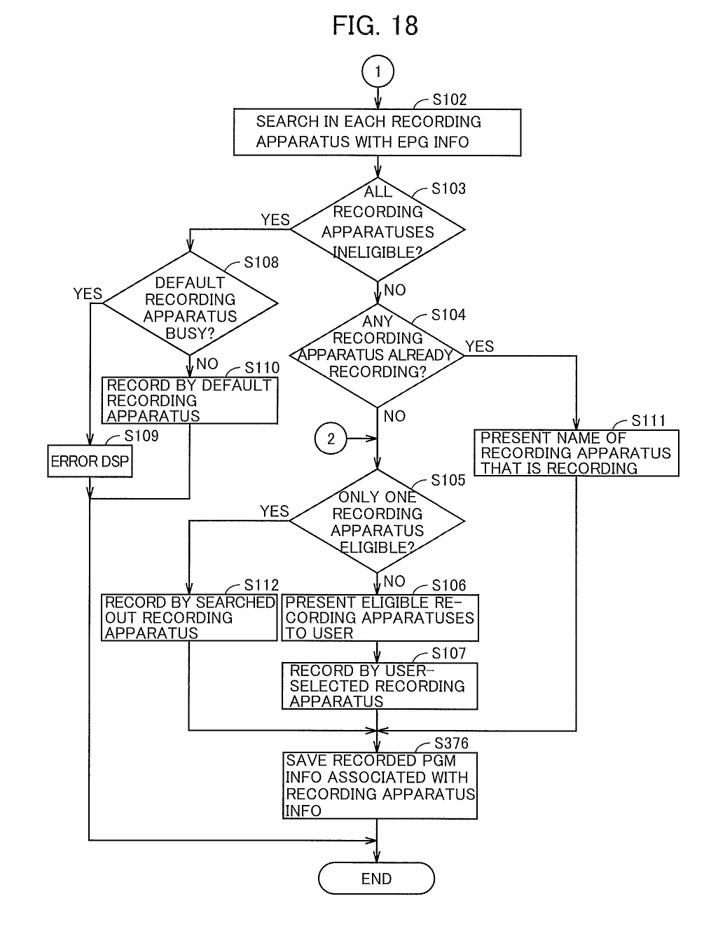

FIGS. 17 and 18 are flowcharts of a program activated when the user instructs recording of a program, for allocating a recording apparatus for executing recording of the program, executed by home NW recording apparatus selection control unit 115, in place of the program having the control structure shown in FIG. 8.

Referring to FIGS. 17 and 18, similar to the program having the control structure shown in FIG. 8, the present program includes S101, S102, S103, S104, S105, S106, S107, S108, S109, S110, S111 and S112. Further, it includes, between S101 and S102, S370, executed after S101, of searching for the recorded program information stored in the program viewing apparatus using the EPG information, and S372, executed following S370, of determining whether there is any recording apparatus that recorded in the past the program of which recording is instructed, among the recorded program information and the recording apparatus information searched at S370, and branching the control flow depending on the result of determination.

As regards the determination at S372, here, determination is made as to whether the broadcast stations and program titles in the recorded program information stored in the program viewing apparatus include any broadcast station or program title matching the broadcast station and the program title in the EPG information.

The program further includes S374, executed if it is determined at S372 that no recording apparatus has recorded the same program, of determining whether or not any recording apparatus has recorded a similar program, and branching the control flow depending on the result of determination.

Here, the determination at S374 is made in accordance with the program having the control structure shown in FIG. 11. In place of the recording history of the recording apparatus compared by the program of FIG. 11, here, the recorded program information stored in the program viewing apparatus is compared with the EPG information. If the determination at S374 is NO, the process proceeds to S102. If determinations at S372 and S374 are YES, the process proceeds to S105.

Referring to FIG. 18, the program further includes S376, executed after S107, S111 and S112, of saving the recorded program information and the information of recording apparatus that recorded the program in association with each other in the storage area in the program viewing apparatus.

—Operation—

The program recording system in accordance with the present embodiment operates in the following manner. For convenience of description, it is assumed that main powers of all components related to the program recording system are on.

If a recording instruction is received from the user, home NW recording apparatus selection control unit 115 activates the program having the control structure shown in FIG. 17. The EPG information of the program is compared with the stored recorded program information, and if the same piece of information as the EPG information is found in the recorded program information, the identifier of the recording apparatus that has been stored in association with the recorded program information is read, and the recording apparatus is identified (YES at S372). Otherwise, the EPG information of the program is compared with the stored recorded program information by the program of FIG. 11. If a similar program has been recorded, the identifier of the recording apparatus that has been stored in association with the recorded program information is read, and the recording apparatus is identified (YES at S374). Thereafter, the process steps are the same as those after S105 of FIG. 8 in the first embodiment. After the recording apparatus is selected, the recorded program information and the recording apparatus information are saved in association with each other (S376). If a default recording apparatus is selected, or in case of an error (S110 and S109), the information is not saved.

In the process above, if an eligible apparatus is not found, home NW recording apparatus selection control unit 115 performs the same process as in the first embodiment.

### Fifth Embodiment

In the fifth embodiment of the present invention, whether or not a recording apparatus on the home NW is eligible for recording a program is determined on the side of the program viewing apparatus. According to the present embodiment, since determination as to whether a recording apparatus is eligible or not is made in the program viewing apparatus, as compared with the first embodiment in which it is necessary to wait for a notice from each of the recording apparatuses on the NW, the time lag from user instruction to execution of recording can be reduced.

—Configuration—

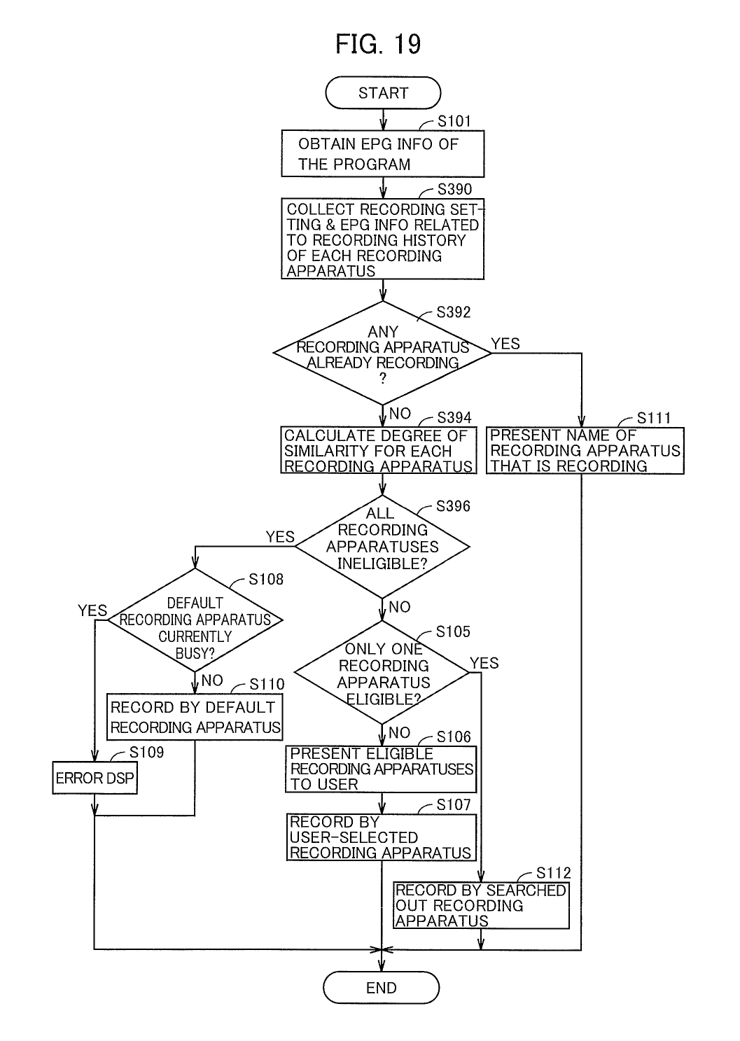

FIG. 19 is a flowchart of a program activated when the user instructs recording of a program, for selecting a recording apparatus for executing recording of the program, executed by home NW recording apparatus selection control unit 115, in place of the program having the control structure shown in FIG. 8.

Referring to FIG. 19, similar to the program having the control structure shown in FIG. 8, the present program includes S101 S105, S106, S107, S108, S109, S110, S111 and S112. In place of S102, S103 and S104, the program includes S390 of collecting pieces of information related to recording settings and recording history from each of the recording apparatuses, and S392, executed after S390, of determining, from the pieces of information collected at S390, whether or not any recording apparatus has already recorded the program, and branching the control flow depending on the result of determination. If it is YES at S392, the process proceeds to S111.

The program further includes S394, executed if it is determined at S392 that no recording apparatus has recorded the program, of calculating degree of similarity on all recording histories of each recording apparatus.

The process of S394 is as follows. From the pieces of information collected at S390, home NW recording apparatus selection control unit 115 forms preference information similar to preference information 240 and 242 shown in FIG. 6 for each recording apparatus. Thereafter, for the EPG information of the program of each recording apparatus, the degree of similarity is calculated as follows. Home NW recording apparatus selection control unit 115 extracts words of the top five rates of appearances corresponding to the genre and performer, from the preference information. The extracted words related to the genre and performer are compared with the EPG information of the program.

If the extracted words related to the genre include the same words as in the EPG information, the rate of appearance of the corresponding word with respect to the total number of appearance of all words related to the genre, which is set to 1, is defined as the degree of similarity A. As to the extracted word corresponding to the performer, similarity is calculated in the same manner as the words corresponding to the genre, and the calculated similarity is defined as degree of similarity B. The results of calculations are input to the equation below, to calculate a general degree of similarity C.

C=A×r+B×(1−r) (1)

Here, r>0.5. Here, if the general degree of similarity is 0.5 or higher, the apparatus is determined to be eligible, and otherwise, it is determined to be ineligible.

The program further includes S396, executed following S394, of determining whether or not all recording apparatuses are ineligible based on the result of calculation at S394. If the determination at S396 is YES, the process proceeds to S108, and if it is NO, the process proceeds to S105.

—Operation—

The program recording system in accordance with the present embodiment operates in the following manner. For convenience of description, it is assumed that main powers of all components related to the program recording system are on.

If a recording instruction is received from the user, home NW recording apparatus selection control unit 115 activates the program having the control structure shown in FIG. 19. Home NW recording apparatus selection control unit 115 compares the EPG information of the program with the pieces of information related to the recording settings and recording history of each of the recording apparatuses collected from the recording apparatuses on the NW (S101 and S390). If there is any recording apparatus that has already recorded the program (S392), home NW recording apparatus selection control unit 115 displays the name of the recording apparatus on display unit 119 (S111). Otherwise, home NW recording apparatus selection control unit 115 calculates the degree of similarity between the recording history of each recording apparatus and the EPG information of the program of interest (S394). Based on the calculated degree of similarity, if only one recording apparatus is determined to be eligible, if a plurality of recording apparatuses are determined to be eligible, or if no recording apparatus is eligible, the process steps are the same as those of the first embodiment.

If a plurality of recording apparatuses are eligible, based on the degree of similarity calculated at S394, the recording apparatuses are displayed in descending order of the degree of similarity, with the name of recording apparatus having the highest degree of similarity displayed in a selected state.

[Modification]

In the embodiments above, the home NW is implemented by wired LAN. The present invention, however, is not limited to such an embodiment. WLAN, PLC (Power Line Communication), IEEE1394 or the like may be adopted.

In the embodiments described above, the program viewing apparatus is a digital TV having the network function. The present invention, however, is not limited to such an embodiment, and any apparatus that is compatible in the home NW, allowing viewing of a program and capable of transmitting a recording instruction to recording apparatuses on the home NW may be used. By way of example, a large-screen monitor connected to an AV personal computer, or a TV not having the network function connected to a network supporting STB (Set Top Box) may be used.

In the embodiments above, the user operation unit of the program viewing apparatus operates upon reception of an instruction from a remote controller. The present invention, however, is not limited to such embodiments. It may be a switch panel provided on the housing of the program viewing apparatus connected to a user operation unit, or, an instruction from a voice controller may be received.

In the embodiments above, the tuner in the program viewing apparatus and in the recording apparatuses is a terrestrial wave digital tuner. The present invention, however, is not limited to such embodiments, and applicable to terrestrial wave or BS (Broadcasting Satellite) analog broadcast, BS and CS (Communication Satellite) digital broadcast, cable broadcast or IP broadcast. Here, the method of obtaining EPG information depends on the method of each broadcast.

In the embodiments above, the processing unit in the program viewing apparatus and in the recording apparatuses is realized by a computer system including a CPU, a memory, an IO and the like as well as control software. The present invention, however, is not limited to such embodiments. By way of example, dedicated LSI (Large Scale Integration) corresponding to each component of the processing unit may be mounted.

In the embodiments above, in a recording apparatus, preference information such as shown in FIG. 6 is calculated based on the recording history, and it is used as an index indicating inclination of recording of the recording apparatus. The preference information, however, may be calculated by adding information related to recording reserved programs, to the recording history.

In the embodiments above, if a plurality of recording apparatuses are eligible, the program viewing apparatus displays the names of the apparatuses on the display unit, and the cursor is focused on the name of the apparatus that has been selected in the immediately preceding operation. It is also possible to set a default recording apparatus for the program viewing apparatus, and the cursor may always be placed on the name of the default recording apparatus.

In the embodiments above, in the program viewing apparatus, after a recording apparatus is selected, the name of the recording apparatus is displayed or not displayed before a recording instruction is issued to the recording apparatus. The present invention, however, is not limited to such embodiments. By way of example, the name of selected recording apparatus or the name of recording apparatus set to record the program may always be displayed. Then, it is possible for the user to confirm which apparatus is used for executing recording.

Further, in connection with the display of recording apparatus mentioned above, the preference information of each recording apparatus may be displayed in association with the name. Specific example will be described in the following. The program viewing apparatus displays, on the display unit, the names of recording apparatuses, and words related to the genre having top two rates of appearances, in the preference information of the corresponding recording apparatus. If a plurality of recording apparatuses are displayed, it is possible for the user to select a recording apparatus suitable for recording the program of interest, by confirming the inclination of recording related to the genre of each of the recording apparatuses. Here, it is assumed that the DMP function of the program viewing apparatus and the DMS function of the recording apparatus include the functions of handling pieces of information related to program attributes such as the genre, keyword and performer. Further, it is assumed that the program viewing apparatus obtains the information of prescribed attribute related to each recording apparatus, at some time point in the communication with the recording apparatuses.

Further, a configuration may be possible in which the user can change the information related to the attributes of the program, when a recording apparatus is to be selected. A specific example will be described in the following. After the names of recording apparatuses are displayed on the display unit of the program viewing apparatus and a recording apparatus is selected, the program title, for example, “A1” and the genre of the program, “movie”, are displayed. The program viewing apparatus separately displays, as a word template related to the genre, candidates such as “animation”, “variety” and “sports”. If the user selects “animation” from the candidates here, the word related to the genre of program A1 is changed to “movie” and “animation”. If the program viewing apparatus instructs the recording apparatus to record program A1, the genres “movie” and “animation” are recorded as pieces of information related to program A1, included in the recording history of the recording apparatus.

From the processes described above, the following effects can be attained. In a recording apparatus having the DMS function, recorded programs can be classified based on attribute values of the programs. By way of example, recorded programs may be grouped genre by genre (movie, animation, variety, sports and the like). In other words, by setting the attribute values of the programs, the recording history can be organized. Therefore, if program A1 mentioned above is to be reproduced, program A1 can easily be searched out from the group of movies or the group of animations, and a desired program can readily be drawn out from the history. If the attribute value of a program is set when recording of the program is instructed as in the process described above, troublesome work such as setting operation afterward on the recorded program becomes unnecessary.

From the viewpoint of program attribute values, it may be possible to consider that all recorded programs and programs-to-be-recorded on a home NW are included in a library of large classification, the programs are classified to middle classifications in accordance with the recording apparatuses on the NW, and further classified to small classifications by the grouping in each recording apparatus. Therefore, the present program recording system enables selection of a recording apparatus owned by an individual without troublesome work, and reduces troublesome work of classifying the library of home NW.

The contents described above applies even when only one program viewing apparatus and only one recording apparatus are connected to the home NW.

In the first to fourth embodiments above, in the program shown in FIG. 11, as regards the genre and keyword among the attributes of preference information in the recording history, if a word of the genre or keyword same as that related to the program of interest is found in the recording history and the rate of appearance of the word exceeds a prescribed threshold, it is determined that a program similar to the program of interest is included in the recording history. The present invention, however, is not limited to such embodiments. By way of example, similar process may be done on words related to the performer, to determine whether or not a program similar to the program of interests is included in the recording history. Further, a configuration may be possible in which the attribute for examining similarity, standard of determination such as the threshold value, and the manner how to calculate and determine the degree of similarity between the program of interest and the recording history can be changed by the user.

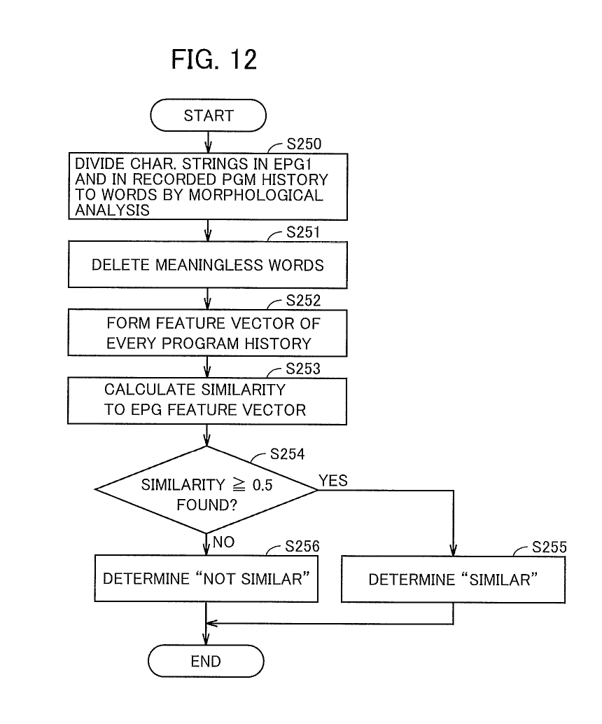

Further, as the method of determining the degree of similarity between the program and the recording history, the determination may be made using the program having the control structure shown in FIG. 12.

FIG. 12 is a flowchart of a program executed by reserved program/recommended program searching unit 215 shown in FIG. 5, for determining whether or not character strings included in the program information (EPG1) and in the recording history are similar, based on the distance between the two, calculated by the vector space method.

Referring to FIG. 12, the present program includes: S250 of dividing object character strings (character strings related to the genre and keyword) into words by morphological analysis, on all pieces of program information in the recording history stored in the recommended program/recording schedule storage unit 222 shown in FIG. 5 of the recording apparatus and in EPG1; and S251, executed after S250, of deleting words not having any meaning, among the words divided at S250. In the following, for description, words derived from EPG1 and the recording history among the words left after the process of S251 will be referred to as EPG1 conent word and recording history content word, respectively.

The program further includes S252, executed after S251, of forming feature vectors for every recording history and EPG1. At S252, reserved program/recommended program searching unit 215 specifically performs the following process. Reserved program/recommended program searching unit 215 puts together the EPG1 content words and the recording history content words, to form a union. The number of elements in the union is represented by N. Reserved program/recommended program searching unit 215 further arranges all words included in the union in a prescribed order, and by representing whether or not these are included by 1.0, it forms a feature vector of every recording history and EPG1. Here, the feature vector is of N-dimension.

The program further includes S253, executed after S252, of calculating degree of similarity to the feature vector of EPG1, of every feature vector of the recording history. The degree of similarity is calculated using the equation below.

$$sim ( d / q ) = \frac{{d}^{->} \times {q}^{->}}{\vert {d}^{->} \vert \times \vert {q}^{->} \vert}$$

Here, sim represents similarity, q represents EPG1, d represents recording history, →q and →d represent feature vectors of EPG1 and the recording history, respectively, and |→q| and |→d| represent magnitude of feature vectors of EPG1 and the recording history, respectively (here, → is originally put over each character).

The program further includes S254, executed following S253, of determining whether or not there is any recording history of which calculated degree of similarity is 0.5 or higher, and branching the control flow depending on the result of determination; and S255, executed if it is determined at S254 that degree of similarity of 0.5 or higher has been found, of determining that EPG1 and the recording history are similar; and S256, executed if it is determined that degree of similarity of 0.5 or higher has not been found, of determining that EPG1 and the recording history are not similar. After S255 and S256, the process ends.

Whether the recording apparatus is eligible or not may be determined using a probabilistic model or a logical model.

Further, as a method of determining the degree of similarity between the program of interest and the recording history, it may be possible to calculate a time zone in which frequency of recording by each recording apparatus is the highest based on the recording history, and to determine whether the time zone matches the broadcasting time of the program of interest. A specific example, will be described in the following. Assume that a recording apparatus owned by a certain individual recorded only programs broadcast between 19:00 to 20:00, while a recording apparatus owned by another individual recorded only programs broadcast between 23:00 to 24:00. If recording of a program broadcast from 19:00 is instructed from a shared program viewing apparatus, the present system selects the former recording apparatus and instructs recording.

Here, assume that the selected recording apparatus is owned by an elementary school kid, and the other recording apparatus is owned by a university student. The time zone of recording of each recording apparatus possibly reflects the life style of the user. The life style here includes the behavior that an elementary school kid records programs on 19:00 with preference while a university student records programs on 23:00 with preference, respectively. Therefore, by selecting a recording apparatus that frequently records in the time zone corresponding to the recording instruction, it is highly likely that the recording apparatus owned by the user who instructed recording is selected. The object of the present invention can also be attained by such an approach.

In the second embodiment described above, in response to the program viewing apparatus receiving the EPG information, recording apparatuses are allocated to every program included in the EPG information. The present invention, however, is not limited to such an embodiment. By way of example, when the user displays an EPG program list on the program viewing apparatus and instructs recording of a specific program to be broadcast, the program viewing apparatus may select a recording apparatus in response. In that case, the program viewing apparatus executes the program having the control structure shown in FIG. 14 on the program, and then, activates the program having the control structure shown in FIG. 15. Here, the program viewing apparatus instructs the eligible recording apparatus to reserve recording.

In the second embodiment above, after the program having the control structure shown in FIG. 14 is executed, when the EPG program list is displayed on the display unit in accordance with a user instruction in the program viewing apparatus, icons indicating recording apparatuses allocated to the programs are displayed on respective rows of programs of the EPG program list. The present invention, however, is not limited to such an embodiment. Any manner of display that can specify the recording apparatus allocated to each program may be used. For example, color of characters of program title displayed in each row or the background color of each row of the program list may be made different in accordance with the allocated recording apparatus.

By such a manner of display, it is possible to confirm the inclination of recording by each recording apparatus owned by an individual at a glance. As a result, family members come to better understand the preferences of each other, leading to better communication in the family.

A specific example will be described in the following. In a house of a family of parents, a daughter and a son, assume that each has his/her own program viewing apparatus and recording apparatus. In addition, assume that they share another program viewing apparatus. Here, assume that father, mother, daughter and son recoded programs belonging to the genres of sports, variety, movie and animation, respectively, by their own recording apparatuses, respectively. When all the family enjoys content on the shared program viewing apparatus, assume that the EPG program list is displayed. In the EPG program list, sports programs are displayed with the indication of recording apparatus owned by the father, on the rows of programs. Similarly, variety programs include display indicating recording apparatus of the mother, movie programs the apparatus of the daughter and animation programs the apparatus of the son. Even if the family members to not much talk about what programs they watch and record regularly, it is possible for each member to know from such display that the father, mother, daughter and son like sports, variety, movie, and animation programs respectively. Further, it is possible to commonly know the activities of each member related to the home NW, for example, to know that the father is going to record a succor game the next day and he will view the program. Such information related to the preference and activity of each member is useful to make everyday conversation in the family lively and comfortable.

In the fifth embodiment above, for the recording history of each recording apparatus stored in the program viewing apparatus, degree of similarity to the EPG information of the program of interest is calculated in accordance with Equation 1, and based on the calculated general degree of similarity, whether or not the recording apparatus is eligible is determined. The present invention, however, is not limited to such an embodiment. The general degree of similarity calculated in accordance with Equation 2 below may be used for determination.

C=B×r+A×(1−r) (2)

Alternatively, degree of similarity A related to the genre, degree of similarity related the performer, or a degree of similarity related to the keyword calculated in the similar manner as degrees of similarity A and B may be used as the standard for determination.

In the fifth embodiment described above, at S106 shown in FIG. 19, corresponding names of the recording apparatuses are displayed on the display unit of program viewing apparatus starting from one having the highest degree of similarity. The present invention, however, is not limited to such an embodiment. By way of example, the order of displaying the names of recording apparatuses may be constant, and prescribed marks may be displayed each time, for respective recording apparatuses in accordance with the calculated degrees of similarity.

In the fifth embodiment described above, based on the degree of similarity between the EPG information of the program of interest and the recording history of each recording apparatus, whether or not a recording apparatus is eligible or not is determined, and from eligible recording apparatuses, one is selected for recording the program. The present invention, however, is not limited to such an embodiment.

For instance, it is possible that a content storage unit of the selected recording apparatus does not have any free space and, hence, recording of the program is impossible even if recording is instructed. In order to avoid such a situation, a recording apparatus may be selected in the following manner.

As a specific example, assume that first and second recording apparatuses owned by individuals are connected to the home NW. The home NW recording apparatus selection control unit of the program viewing apparatus collects pieces of information related to recording setting and recording history of each recording apparatus (S390 of FIG. 19) and, at this time, it additionally collects information related to the free space of the content storage unit of each recording apparatus. Assume that by the program of FIG. 19, the first recording apparatus is selected. The home NW recording apparatus selection control unit determines, from the information of the program, whether or not recording of the program is possible with the free space of the content storage unit of the first recording apparatus. If it is determined that recording is possible, the home NW recording apparatus selection control unit instructs the first recording apparatus to record the program. Otherwise, the home NW recording apparatus selection control unit determines whether or not recording of the program is possible, from the free space of the content storage unit of the second recording apparatus. If it is determined that recording is possible, the home NW recording apparatus selection control unit instructs the second recording apparatus to record the program, and otherwise, it displays an error indication and ends the process.

The process above is effective to avoid unsuccessful recording of the program, when the free space is insufficient.

Here, assume that the second recording apparatus having sufficient free space is selected by the process above. The home NW recording apparatus selection control unit of the program viewing apparatus instructs the second recording apparatus to record the program, transmits information related to the program and information that the second recording apparatus executed the recording of the program, to the first recording apparatus, and instructs to save such information with the recording history. Thus, the owner of the first recording apparatus can confirm, when the program viewing apparatus has the recording history of the first recording apparatus displayed, that the program has been recorded by the second recording apparatus.

By the process above, the owner of the first recording apparatus can avoid missing the opportunity to view the program. Specifically, since the recording apparatus owned by him/her has the location of the program content and, therefore, he/she can view the program by reproducing it on the second recording apparatus when he/she wishes to.

Further, here, a configuration may be possible that the program recorded by the second recording apparatus can be reproduced and viewed by an operation from the first recording apparatus. A specific example will be described in the following. Assume that the program viewing apparatus is owned by the same user as the first recording apparatus, and is placed in the user's room. When the recording history of the first recording apparatus is displayed on the program viewing apparatus, a short-cut appears indicating the second recording apparatus as related to the program. If the user selects the short-cut, the program recorded on the second recording apparatus is downloaded to the first recording apparatus, and the first recording apparatus starts reproduction of the program and provides outputs to the program viewing apparatus. Here, it is assumed that the first recording apparatus has free space large enough to allow downloading. In another possible example, when the short-cut is selected, reproduction of the recorded program starts in the second recording apparatus, and the reproduced video and audio information may be output from the second recording apparatus to an external device.

By such a process, even when the free space of the recording apparatus owned by the user was too small and recording could not be done, the user can enjoy viewing the program in his/her room. In other words, he/she can form his/her library without regard to the free space of his/her recording apparatus.

In connection with the selection of a recording apparatus in accordance with the fifth embodiment, it is also possible that a user wishes to have a specific program recorded with high quality. The specific program may include a movie program or a program of high-vision broadcast. In view of such a demand, a recording apparatus may be selected in the manner as described in the following.

The home NW recording apparatus selection control unit of the program viewing apparatus obtains and stores pieces of information such as shown in FIG. 4 with respect to the apparatuses connected to the home NW and, in addition, it obtains and stores pieces of information as to whether the apparatus supports an external medium, such as disk medium including BD (Blu-ray Disk (registered trademark)) and HD-DVD (High Definition-Digital Versatile Disk) and tape media, allowing so-called large volume recording and whether or not it has a recorder function capable of high-quality recording and high-vision digital data recording. Further, it is assumed that in the recording apparatus having the recorder function, high-quality recording is set for recording a movie program and high-vision digital data recording is set for a program of high-vision broadcast.

In response to a recording instruction, the home NW recording apparatus selection control unit obtains the pieces of information such as shown in FIG. 4, and information as to whether each recording apparatus has the recorder function. Thereafter, assume that a recording apparatus is selected by the program shown in FIG. 19. Here, from the information related to the program, the home NW recording apparatus selection control unit determines whether the program corresponds to a movie program or a high vision broadcast program. If it corresponds, whether or not the recording apparatus has the recorder function described above is determined. If it has the recorder function, the home NW recording apparatus selection control unit instructs the recording apparatus to record the program. Otherwise, it again selects another recording apparatus that has the recorder function from among the eligible recording apparatuses. If no recording apparatus is eligible, an error display is made, and the process ends.

By the process described above, in the automatic selection of a recording apparatus and execution of recording by the present system, it is possible to selectively execute high-quality recording of a specific program.

In the process described above, the home NW recording apparatus selection control unit may obtain pieces of information related to the recorder function of each recording apparatus in the following manner.

The home NW recording apparatus selection control unit obtains and stores product name and model number of each of the apparatuses connected to the NW, in addition to the pieces of information shown in FIG. 4. The program viewing apparatus includes, separate from the components shown in FIG. 2, a database storing the product names and model numbers of the apparatuses in association with the specifications of respective apparatuses such as the recorder function.

In response to a recording instruction, the home NW recording apparatus selection control unit obtains, from the home NW setting storage unit, the pieces of information shown in FIG. 4 and the information related to the product name and model number. Further, the home NW recording apparatus selection control unit searches the database using the obtained information of product name and model number to find if the corresponding apparatus has the above-described recorder function.

In the embodiments above, one program viewing apparatus selects a recording apparatus and instructs the selected recording apparatus to record. A plurality of program viewing apparatuses on the home NW may select recording apparatuses and instruct recording, respectively. In that case, a plurality of program viewing apparatuses may issue search requests to one same recording apparatus or instruct one same recording apparatus to record. In that case, instruction of the program viewing apparatus that received earlier is given priority. The instruction of the program viewing apparatus received later leads to error indication and ends, as the corresponding recording apparatus is busy. A recording apparatus may include a plurality of tuners. In that case, even if the recording apparatus receives recording instructions of different channels from the plurality of program viewing apparatuses, the recording apparatus can process the instructions in parallel.

The embodiments as have been described here are mere examples and should not be interpreted as restrictive. The scope of the present invention is determined by each of the claims with appropriate consideration of the written description of the embodiments and embraces modifications within the meaning of, and equivalent to, the languages in the claims.

### INDUSTRIAL APPLICABILITY

The present invention is usable in the field of industry of manufacturing, offering or leasing a recording requesting apparatus, a recording apparatus and a system including such a recording requesting apparatus and recording apparatus capable of executing recording of a program without necessitating any troublesome work and operations by the user.

1-40. (canceled)

41. A recording requesting apparatus connected to a network having a recording apparatus or recording apparatuses connected thereto, comprising:
program information obtaining means for obtaining program information related to a specific program;
recording apparatus detecting means for detecting the recording apparatus or recording apparatuses connected to said network;
a search request transmitting means for transmitting, through said network, a search request for the program information obtained by said program information obtaining means, to the recording apparatus or recording apparatuses detected by said recording apparatus detecting means;
recording apparatus selecting means for selecting a recording apparatus for recording said program, based on a notice or notices from said recording apparatus or recording apparatuses transmitted in response to said search request from said search request transmitting means; and
recording request transmitting means for transmitting a recording request related to recording of said program, to the recording apparatus selected by said recording apparatus selecting means.

42. The recording requesting apparatus according to claim 41, further comprising
program list information obtaining means for obtaining program list information including the program information; wherein
said program information obtaining means includes means for obtaining the program information included in the program list information obtained by said program list information obtaining means.

43. The recording requesting apparatus according to claim 42, wherein said program list information obtaining means includes means for obtaining the program list information from a server storing the program list information through said network.

44. The recording requesting apparatus according to claim 42, further comprising:
broadcast signal processing means for receiving broadcast signals, and processing and outputting program list information included in said broadcast signals; and
program list information storage means for storing the program list information output from said broadcast signal processing means.

45. The recording requesting apparatus according to claim 44, wherein said program list information obtaining means includes means for obtaining program list information stored in said program information storage means.

46. The recording requesting apparatus according to claim 44, wherein
said broadcast signal is an RF signal; and
said broadcast signal processing means includes means for receiving RF signals and processing and outputting program list information included in the RF signals.

47. The recording requesting apparatus according to claim 44, wherein
said broadcast signal is streaming data of IP multicast; and
said broadcast signal processing means includes means for receiving the streaming data and processing and outputting program list information included in the streaming data.

48. The recording requesting apparatus according to claim 44, further comprising display means for displaying either or both of said video signal output from said broadcast signal processing means and the program list information read from said program list information storage means, in accordance with a user instruction.

49. The recording requesting apparatus according to claim 48, wherein said search request transmitting means includes means for obtaining information related to a program of which recording is requested by the user and of which video signals are being output to said display means, and for transmitting, to a recording apparatus or recording apparatuses detected by said recording apparatus detecting means, a search request related to said program through said network.

50. The recording requesting apparatus according to claim 48, wherein said search request transmitting means includes means for obtaining information related to a program selected by the user from a program list that is being output by said display means, from the program list information stored in said program list information storage means, and for transmitting a search request related to said program to a recording apparatus or recording apparatuses detected by said recording apparatus detecting means, through said network.

51. The recording requesting apparatus according to claim 48, wherein
said recording apparatus selecting means includes
first determining means for determining, if no recording apparatus notifies that it will execute recording of said program, and a recording apparatus or recording apparatuses notify eligibility for recording said program, whether or not only one recording apparatus is eligible, and
means for displaying, if it is determined by said first determining means that more than one recording apparatuses are eligible, information related to the corresponding recording apparatuses on said display means, and for receiving selection by the user.

52. The recording requesting apparatus according to claim 51, wherein said recording apparatus selecting means further includes second determining means for determining, if no recording apparatus notifies that it will execute recording of said program, and no recording apparatus notifies eligibility for recording said program, based on a notice from a predetermined recording apparatus, whether or not recording of the program is possible by said predetermined recording apparatus.

53. The recording requesting apparatus according to claim 52, wherein said recording request transmitting means includes means for transmitting, if it is determined by said first determining means that only one recording apparatus is eligible or if it is determined by said second determining means that recording of said program is possible by said predetermined recording apparatus, a request related to recording of said program to the recording apparatus and, otherwise, for transmitting a request related to recording of said program to the recording apparatus selected by said selecting means.

54. The recording requesting apparatus according to claim 48, wherein
said search request transmitting means includes
means for starting time measurement in response to a channel switch instruction from the user, and if new channel switch instruction is not received even after a prescribed time period, for determining a program of which video signals are being output by said display means to be said specific program, and
means for obtaining information related to said program from the program list information stored in said program list information storage means, and for transmitting a search request related to said program to a recording apparatus or recording apparatuses detected by said recording apparatus detecting means, through said network.

55. The recording requesting apparatus according to claim 44, further comprising means for controlling said search request transmitting means and said recording apparatus selecting means such that, when said broadcast signal processing means receives the broadcast signals, regarding each of a plurality of programs of which related information is included in the program list information in the broadcast signals as a specific program, a series of operations related to the specific program is performed, whereby a recording apparatus for recording the program is selected for each of said plurality of programs.

56. The recording requesting apparatus according to claim 41, further comprising:
recording history storage means for storing pieces of information related to a recorded program or programs and an identifier of a recording apparatus that recorded the recorded program in association with each other; and
means for obtaining, when the user instructs recording of said specific program, information related to the recorded program from the information stored in said recording history storage means; wherein
said information related to the program and said information related to the recorded program each include a prescribed attribute value;
said recording requesting apparatus further comprising:
execution causing means, comparing the information related to said program with the information related to said recorded program, determining, if a value of said prescribed attribute included in the information related to said program and a value of said prescribed attribute included in any of said pieces of information related to the recorded programs satisfy a prescribed similarity relation, that a recording apparatus indicated by the identifier stored in association with the piece of information related to the recording apparatus in said recording history storage means is eligible for recording said program, and otherwise for causing said search request transmitting means to execute a process; wherein
said recording apparatus selecting means includes
means for selecting a recording apparatus for recording said program based on a result of determination by said execution causing means and a notice from said recording apparatus, and
means for storing, based on the notice from the recording apparatus and said recording request transmitting means transmitted the request related to recording of said program, the information related to said program and an identifier of a recording apparatus for recording said program in association with each other in said recording history storage means.

57. The recording requesting apparatus according to claim 41, wherein
said recording apparatus selecting means includes
means, selecting, based on a notice or notices from said recording apparatus or recording apparatuses transmitted in response to said search request from said search request transmitting means, a recording apparatus for recording said program, for storing an identifier of the selected recording apparatus in association with information related to said program, and
means for reading, when the user instructs recording of said program, said identifier of the recording apparatus stored in association with said information related to the program from said means for storing, and for selecting the recording apparatus identified by said identifier to be the recording apparatus for recording said program.

58. The recording requesting apparatus according to claim 57, wherein
said means for storing includes
first storage means for storing, if no recording apparatus notifies that it will execute recording of said program, and a recording apparatus or recording apparatuses notify eligibility for recording said program, an identifier or identifiers of the recording apparatuses in association with the information related to said program, and
second storage means, determining, if no recording apparatus notifies that it will execute recording of said program, and no recording apparatus notifies eligibility for recording said program, based on a notice from a predetermined recording apparatus, whether or not recording of the program is possible by said predetermined recording apparatus, and if it is determined that recording of said program by said predetermined recording apparatus is possible, for storing an identifier of said predetermined recording apparatus in association with the information related to said program;
said means for selecting includes
means for reading, when the user instructs recording of said specific program, the identifier of a recording apparatus stored in association with said program by said first or second storage means,
first selecting means, if only one identifier is read by said reading means, for selecting the recording apparatus identified by said identifier as the recording apparatus for recording the program,
second selecting means, if a plurality of identifiers are read by said reading means, for displaying information related to the recording apparatuses identified by the identifiers and, if the user selects any of the displayed recording apparatuses, for selecting the recording apparatus to be the recording apparatus for recording said program, and
means for presenting an error display to the user, if no identifier is stored by said first or second storage means.

59. The recording requesting apparatus according to claim 41, wherein said recording request related to recording of said program is a request for reserving recording.

60. The recording requesting apparatus according to claim 41, wherein said program information obtaining means includes means for obtaining program information from any of an electronic mail received from another apparatus, information extracted from a bar code, and an identifier of program information input by the user.

61. A recording apparatus connected to a network having at least one recording requesting apparatus connected thereto, wherein
said recording requesting apparatus transmits a search request including information of a specific program, related to said program, to said recording apparatus;
said recording apparatus comprising:
recording information storage means for storing recording information including recording history or/and recording plan by said recording apparatus;
determining means for comparing said information related to the program specified by said search request received from said recording requesting apparatus with said recording information stored in said recording information storage means, for determining whether or not the recording apparatus is eligible for recording said program, in accordance with the result of comparison;
notifying means for providing a notice in accordance with the result of determination by said determining means, to the recording requesting apparatus that transmitted said search request; and
recording process executing means, responsive to a request related to recording of said program transmitted from said recording requesting apparatus, for executing a process related to recording of said program.

62. The recording apparatus according to claim 61, wherein
said information related to the program includes information related to broadcast time of said program;
said recording apparatus further comprising:
first determining means for comparing the information related to said program included in said search request received from said recording requesting apparatus with state of operation of said recording apparatus, for determining whether or not said recording apparatus will be recording at the broadcast time of said program; and
second determining means for determining, if it is determined by said first determining means that the recording apparatus will be recording at the broadcast time, whether or not the program that will be recorded by said recording apparatus at the broadcast time is the same as said program.

63. The recording apparatus according to claim 62, further comprising means for providing, if it is determined by said second determining means that the program that will be recorded by said recording apparatus at the broadcast time is the same as said program, a notice that recording of said program will be executed by said recording apparatus and, otherwise, a notice that the recording apparatus will be recording another program, to the recording requesting apparatus that transmitted the search request.

64. The recording apparatus according to claim 61, wherein
said recording information includes pieces of information related to a plurality of recorded and to-be-recorded programs;
said information related to the program and each of said pieces of information related to the recorded and to-be-recorded programs each include a prescribed attribute value; and
said determining means includes first determining means for comparing said information related to the program with each of said pieces of information related to the recorded and to-be-recorded programs stored in said recording information storage means, for determining, if said prescribed attribute value included in said information related to the program and said prescribed attribute value included in any of said pieces of information related to the recorded and to-be-recorded programs satisfy a prescribed similarity relation, that the recording apparatus is eligible for recording said program.

65. The recording apparatus according to claim 64, wherein
said to-be-recorded program includes a reserved program of which recording is reserved;
said recording apparatus further comprising means for calculating, based on said prescribed attribute value included in each of said pieces of information related to the recorded and to-be-recorded programs stored in said recording information storage means, inclination related to said prescribed attribute; wherein
said first determining means includes second determining means, comparing the information related to said program included in said received search request with each of the pieces of information related to the recorded and to-be-recorded programs stored in said recording information storage means, and if said prescribed attribute value included in said information related to the program and said prescribed attribute value included in any of said pieces of information related to the recorded and to-be-recorded programs satisfy a prescribed similarity relation, for determining whether the recording apparatus is eligible for recording said program, in accordance with result of calculation of inclination related to said prescribed attribute by said calculating means.

66. The recording apparatus according to claim 65, further comprising:
program list information storage means, receiving broadcast signals, processing program list information included in said broadcast signals, for storing said program list information; and
recommended program extracting means for extracting, in accordance with the result of calculation of inclination related to said prescribed attribute calculated by said calculating means, a program of which recording is recommended to the user from programs of which related pieces of information are included in the program list information stored in said program list information storage means; wherein
said to-be-recorded programs include a reserved program of which recording is reserved and the recommended program extracted by said recommended program extracting means; and
said first determining means further includes execution causing means for determining whether or not the recommended program or programs extracted by said recommended program extracting means include the same program as said program, and if the recommended program or programs include the same program as said program, for determining that the recording apparatus is eligible for recording said program, and otherwise, for causing said second determining means to execute the process.

67. The recording apparatus according to claim 64, wherein said notifying means includes means for providing, if it is determined by said first determining means that the recording apparatus is eligible for recording said program, a notice that the apparatus is eligible for recording the program, and otherwise, a notice that the recording apparatus in ineligible for recording the program, to the recording requesting apparatus that transmitted the search request.

68. The recording apparatus according to claim 64, wherein said prescribed attribute value includes a word.

69. The recording apparatus according to claim 64, wherein said prescribed attribute value includes a word sequence indicating genre of a program, a word sequence indicating a keyword, or a word sequence indicating a performer, or an arbitrary combination of these.

70. The recording apparatus according to claim 64, further comprising attribute changing means for changing said prescribed attribute value in accordance with a user operation.

71. The recording apparatus according to claim 64, further comprising similarity relation setting changing means for changing setting related to said prescribed similarity relation in accordance with a user operation.

72. The recording apparatus according to claim 61, wherein
said recording information includes pieces of information related to a plurality of recorded and to-be-recorded programs; and
said determining means includes
similarity degree calculating means for calculating degree of similarity between the information related to said program specified by said received search request and each of said pieces of information related to the recorded and to-be-recorded programs, and
first determining means for determining, if any of the degrees of similarity calculated by said similarity degree calculating means is equal to or higher than a predetermined threshold value, the recording apparatus to be eligible for recording said program.

73. The recording apparatus according to claim 72, wherein said information related to said program and each of said pieces of information related to the recorded and to-be-recorded programs include a character string.

74. The recording apparatus according to claim 72, further comprising similarity degree setting changing means for changing settings related to a method of calculating the degree of similarity by said similarity degree calculating means and related to said predetermined threshold value, in accordance with a user operation.

75. A recording requesting apparatus connected to a network having a recording apparatus or recording apparatuses connected thereto, comprising:
broadcast signal processing means, receiving broadcast signals, for executing a process for decoding and outputting video and audio signals included in the broadcast signals of a designated channel and processing and outputting a program list information included in said broadcast signals;
program list information storage means for storing said program list information output from said broadcast signal processing means;
display means for displaying either or both of said video signal output from said broadcast signal processing means and the program list information read from said program list information storage means, in accordance with a user instruction;
recording apparatus detecting means for detecting the recording apparatus or recording apparatuses connected to said network;
means for obtaining information related to a specific program from said program list information stored in said program list information storage means; and
recording information transmission requesting means for transmitting a transmission request related to recording information through said network to the recording apparatus or recording apparatuses detected by said recording apparatus detecting means; wherein
said recording information includes recording history and recording plan by said recording apparatus;
said recording requesting apparatus further comprising:
recording apparatus selecting means, comparing the information related to said program obtained by said obtaining means with each piece of recording information of said recording apparatus received from said recording apparatus or recording apparatuses in response to the transmission request from said recording information transmission request, for selecting a recording apparatus for recording said program in accordance with the result of comparison; and
recording request transmitting means for transmitting a recording request related to recording of said program, to the recording apparatus selected by said recording apparatus selecting means.

76. A recording apparatus connected to a network having at least one recording requesting apparatus connected thereto, comprising:
recording information storage means for storing recording information including recording history or/and recording plan by said recording apparatus;
means, responsive to a transmission request for recording information transmitted from said recording requesting apparatus, for transmitting the recording information stored in said recording information storage means; and
recording process executing means, responsive to a request related to recording of a program transmitted from said recording requesting apparatus, for executing a process related to recording of said program.

77. A system including at least one recording requesting apparatus and a plurality of recording apparatuses connected to a network, wherein
said recording requesting apparatus includes
broadcast signal processing means, receiving broadcast signals, for executing a process for decoding and outputting video and audio signals included in the broadcast signals of a designated channel and processing and outputting a program list information included in said broadcast signals,
program list information storage means for storing said program list information output from said broadcast signal processing means,
display means for displaying either or both of said video signal output from said broadcast signal processing means and the program list information read from said program list information storage means, in accordance with a user instruction,
recording apparatus detecting means for detecting a recording apparatus or recording apparatuses connected to said network, and
search request transmitting means, for obtaining information related to a specific program from said program list information stored in said program list information storage means, and for transmitting a search request related to said program through said network to the recording apparatus or recording apparatuses detected by said recording apparatus detecting means; wherein
said search request includes information related to said program;
said recording apparatus includes
recording information storage means for storing recording information including either or both of recording history and recording plan of said recording apparatus,
determining means, comparing said information related to the program specified by said search request received from said recording requesting apparatus with said recording information stored in said recording information storage means, for determining whether or not the recording apparatus is eligible for recording said program, in accordance with the result of comparison, and
notifying means for providing a notice in accordance with the result of determination by said determining means, to the recording requesting apparatus that transmitted said search request;
said recording requesting apparatus further includes
recording apparatus selecting means for selecting a recording apparatus for recording said program, based on notices from said plurality of recording apparatuses, and
recording request transmitting means for transmitting a request related to recording of said program, to the recording apparatus selected by said recording apparatus selecting means; and
said recording apparatus further includes
recording process executing means, responsive to the request related to recording of said program transmitted from said recording requesting apparatus, for executing a process related to recording of said program.

78. A method of selecting a recording apparatus in a system including at least one recording requesting apparatus and a plurality of recording apparatuses connected to a network, wherein
said recording requesting apparatus includes
program list information storage means, receiving broadcast signals, processing program list information included in said broadcast signals, for storing said program list information,
recording apparatus detecting means for detecting the recording apparatuses connected to the network, and
search request transmitting means, obtaining information related to a specific program from said program list information stored in said program list information storage means, for transmitting, through said network, a search request related to said program to the recording apparatuses detected by said recording apparatus detecting means;
said search request includes information related to said program;
said recording apparatus includes
recording information storage means for storing recording information including either or both of recording history and recording plan of said recording apparatus,
determining means, comparing said information related to the program specified by said search request received from said recording requesting apparatus with said recording information stored in said recording information storage means, for determining whether or not the recording apparatus is eligible for recording said program, in accordance with the result of comparison, and
notifying means for providing a notice in accordance with the result of determination by said determining means, to the recording requesting apparatus that transmitted said search request;
said recording requesting apparatus further includes
recording apparatus selecting means for selecting a recording apparatus for recording said program, based on notices from said plurality of recording apparatuses, and
recording request transmitting means for transmitting a request related to recording of said program, to the recording apparatus selected by said recording apparatus selecting means; and
said recording apparatus further includes
recording process executing means, responsive to the request related to recording of said program transmitted from said recording requesting apparatus, for executing a process related to recording of said program;
said recording apparatus selecting method comprising:
program information obtaining step of said search request transmitting means obtaining information related to a specific program from said program list information stored in said program list information storage means;
program information transmitting step of said search request transmitting means transmitting a search request related to said program to the recording apparatuses detected by said recording apparatus detecting means, through said network;
determining step of said determining means of comparing, in response to reception of said search request transmitted from said recording requesting apparatus by said recording apparatus, said information related to the program specified by said search request with the recording information stored in said recording information storage means, and in accordance with the result of determination, determining whether or not the recording apparatus is eligible for recording said program;
notifying step of said notifying means of transmitting a notice in accordance with the result of determination at said determining step, to the recording requesting apparatus that transmitted said search request;
recording apparatus selecting step of said recording apparatus selecting means selecting, based on the notices from said plurality of recording apparatuses at said notifying step, a recording apparatus for recording said program;
recording process request transmitting step of said recording process request transmitting means transmitting a request related to recording of said program to the recording apparatus selected at said recording apparatus selecting step; and
said recording process executing means executing the process related to recording of said program, in response to the request related to recording of said program transmitted from said recording requesting apparatus at said recording process request transmitting step.

79. In a recording requesting apparatus connected to a network having a recording apparatus or recording apparatuses connected thereto, including
program list information storage means, receiving broadcast signals, processing program list information included in said broadcast signals, for storing said program list information,
communication means for communicating with said recording apparatus through said network, and
a computer capable of reading the program list information stored in said program list information storage means and capable of controlling said communication means,
a computer program executed by said computer for selecting a recording apparatus suitable for recording a specific program, said computer program causing said computer to function as:
recording apparatus detecting means for detecting said recording apparatus or recording apparatuses through said communication means;
program information obtaining means for obtaining information related to said program from the program list information stored by said program list information storage means;
search request transmitting means for transmitting, to the recording apparatus or recording apparatuses detected by said recording apparatus detecting means, a search request related to said program including information related to said program, by controlling said communication means;
recording apparatus selecting means for selecting a recording apparatus for recording said program, based on a notice or notices transmitted from said recording apparatus or recording apparatuses in response to said search request from said search request transmitting means and received by said communication means; and
recording request transmitting means for transmitting a recording request related to recording of said program to the recording apparatus selected by said recording apparatus selecting means by controlling said communication means.

80. In a recording apparatus connected to a network having at least one recording requesting apparatus, wherein
said recording requesting apparatus transmits a search request related to a specific program, including information related to said program, to said recording apparatus; and
said recording apparatus includes
recording information storage means for storing recording information including either or both of recording history and recording plan of said recording apparatus,
communication means for communication with said recording requesting apparatus through said network,
recording process executing means for executing a process related to recording of the program, and
a computer capable of reading recording information stored in said recording information storage means, and capable of controlling said communication means and said recording process executing means;
a computer program executed by said computer, for performing a process related to recording of said program,
said computer program causing said computer to function as:
determining means, responsive to said communication means receiving said search request from said recording requesting apparatus, for comparing said information related to the program specified by said search request with the recording information stored in said recording information storage means, and for determining whether or not the recording apparatus is eligible for recording said program in accordance with the result of comparison;
notifying means for transmitting a notice in accordance with the result of determination by said determining means to the recording requesting apparatus that transmitted said search request, by controlling said communication means; and
means for controlling said recording process executing means to function as means for executing a process related to recording of said program, in response to said communication means receiving a request related to recording of said program transmitted from said recording requesting apparatus.
